(19) United States
(12) Patent Application Publication
(10) Pub. No.: US 2026/0269538 A1
(43) Pub. Date: Sep. 10, 2026

(54) ELECTRICAL CONNECTOR AND CONNECTOR ASSEMBLY WITH IMPROVED SHIELDING CONFIGURATIONS

(71) Applicant: DONGGUAN LUXSHARE TECHNOLOGIES CO., LTD, Dongguan City (CN)

(72) Inventors: Hengshan CHENG, Dongguan City (CN); Chuanqi GONG, Dongguan City (CN); Hongji CHEN, Dongguan City (CN)

(73) Assignee: DONGGUAN LUXSHARE TECHNOLOGIES CO., LTD, Dongguan City (CN)

(21) Appl. No.: 19/367,307

(22) Filed: Oct. 23, 2025

Related U.S. Application Data
(63) Continuation-in-part of application No. 19/327,494, filed on Sep. 12, 2025.

(30) Foreign Application Priority Data
Mar. 7, 2025 (CN) 202510274968.1
Jun. 30, 2025 (CN) 202510897402.4

(51) Int. Cl. H01R 13/6587; H01R 12/70; H01R 13/631; H01R 13/6594; H01R 31/00

(52) U.S. Cl. CPC H01R 13/6587; H01R 12/707; H01R 13/631; H01R 31/005; H01R 13/6594

(57) ABSTRACT

An electrical connector includes a mounting frame and a shielding module. The mounting frame includes a base plate portion and a mounting space. The base plate portion includes a number of module receiving holes. The shielding module is at least partially received in the mounting space. The shielding module includes a shielding shell assembly and a number of terminal modules. The shielding shell assembly includes a number of shielding cavities. The terminal module is at least partially received in the shielding cavity. The module receiving hole corresponds to the shielding cavity and is in communication with each other. A connector assembly including the electrical connector is also disclosed.

### CROSS-REFERENCE TO RELATED APPLICATIONS

This patent application is a continuation-in-part of U.S. application Ser. No. 19/327,494, filed on Sep. 12, 2025 and titled “ELECTRICAL CONNECTOR AND CONNECTOR ASSEMBLY WITH IMPROVED SHIELDING ASSEMBLY”, and claims priority of a Chinese Patent Application No. 202510897402.4, filed on Jun. 30, 2025 and titled “ELECTRICAL CONNECTOR AND CONNECTOR ASSEMBLY” and Chinese Patent Application No. 202510274968.1, filed on Mar. 7, 2025 and titled “FIRST ELECTRICAL CONNECTOR AND CONNECTOR ASSEMBLY”. The entire contents of the aforementioned applications are incorporated herein by reference in their entirety.

### TECHNICAL FIELD

The present disclosure relates to an electrical connector and a connector assembly, which belongs to the field of connector technology.

### BACKGROUND

A connector assembly in the related art generally includes an electrical connector and a mating connector for mating with the electrical connector. The electrical connector is usually provided with a shielding cavity, and the mating connector is usually provided with a shielding member inserted into the shielding cavity.

With the continuous increase in signal transmission requirements, the terminal density in related technologies is increasing. At the same time, how to improve the mating accuracy of the mating connector and the electrical connector is a technical problem to be solved by those skilled in the art.

### SUMMARY

An embodiment of the present disclosure adopts the following technical solution: an electrical connector including: a mounting frame, the mounting frame including a base plate portion and a mounting space, the base plate portion defines a plurality of module receiving holes; and a shielding module, the shielding module being at least partially received in the mounting space; the shielding module including a shielding shell assembly and a plurality of terminal modules; the shielding shell assembly defining a plurality of shielding cavities, the terminal modules being at least partially received in the shielding cavities; the module receiving holes corresponding to and communicating with the shielding cavities.

An embodiment of the present disclosure also adopts the following technical solution: a connector assembly including: an electrical connector including: a mounting frame, the mounting frame including a base plate portion and a mounting space, the base plate portion defines a plurality of module receiving holes; and a shielding module, the shielding module being at least partially received in the mounting space; the shielding module including a shielding shell assembly and a plurality of terminal modules; the shielding shell assembly defining a plurality of shielding cavities, the terminal modules being at least partially received in the shielding cavities; the module receiving holes corresponding to and communicating with the shielding cavities; and a mating connector including a plurality of metal shield enclosures; wherein the metal shield enclosures are configured to pass through the module receiving holes of the electrical connector to be at least partially received in the shielding cavities of the electrical connector.

### BRIEF DESCRIPTION OF DRAWINGS

FIG. 1 is a perspective schematic view of a connector assembly in accordance with a first embodiment of the present disclosure;

FIG. 2 is a perspective view of FIG. 1 from another angle;

FIG. 3 is a partially exploded view of FIG. 1;

FIG. 4 is a further partially exploded view of FIG. 3;

FIG. 5 is a partially exploded view of FIG. 4 from another angle;

FIG. 6 is a partial enlarged view of circle part B in FIG. 5;

FIG. 7 is a top view of an electrical connector and a circuit board in FIG. 4 when they are separated from each other;

FIG. 8 is a partial enlarged view of frame part C in FIG. 7;

FIG. 9 is a partial enlarged view of frame part D in FIG. 7;

FIG. 10 is a bottom view of FIG. 7;

FIG. 11 is a partial enlarged view of frame part E in FIG. 10;

FIG. 12 is a partially exploded view of the electrical connector of FIG. 4;

FIG. 13 is a partial enlarged view of circle part F in FIG. 12;

FIG. 14 is a top view of a mounting frame, a shielding shell assembly and a plurality of terminal modules in FIG. 12;

FIG. 15 is a bottom view of FIG. 14;

FIG. 16 is a further partially exploded view of FIG. 12;

FIG. 17 is a partially exploded view of FIG. 16 from another angle;

FIG. 18 is a top view of an inner frame and an outer frame in FIG. 16 when the inner frame and the outer frame are dislocated to each other;

FIG. 19 is a bottom view of FIG. 18;

FIG. 20 is a perspective schematic view of the electrical connector in FIG. 4 in accordance with a second embodiment of the present disclosure;

FIG. 21 is a perspective schematic view of FIG. 20 from another angle;

FIG. 22 is a partially exploded view of FIG. 21;

FIG. 23 is a partially exploded view of FIG. 22 from another angle;

FIG. 24 is a partially exploded view of the electrical connector of FIG. 5, wherein a connecting plate is separated;

FIG. 25 is a partial enlarged view of circle part G in FIG. 24;

FIG. 26 is a partial enlarged view of circle part H in FIG. 24;

FIG. 27 is a partially exploded view of FIG. 24 from another angle;

FIG. 28 is a perspective view of a shielding module in FIG. 12;

FIG. 29 is a perspective schematic view of FIG. 28 from another angle;

FIG. 30 is a partially exploded view of FIG. 28;

FIG. 31 is a partially exploded view of FIG. 30 from another angle;

FIG. 32 is a perspective exploded view of the terminal module in FIG. 30;

FIG. 33 is a perspective exploded view of FIG. 32 from another angle;

FIG. 34 is a cross-sectional schematic view of the electrical connector taken along line M-M in FIG. 4;

FIG. 35 is a partial enlarged view of frame part I in FIG. 34;

FIG. 36 is a cross-sectional schematic view of the connector assembly taken along line N-N in FIG. 1;

FIG. 37 is a partial enlarged view of frame part J in FIG. 36;

FIG. 38 is a cross-sectional schematic view of the connector assembly taken along line O-O in FIG. 1;

FIG. 39 is a partial enlarged view of frame part K in FIG. 38;

FIG. 40 is a perspective schematic view of a cable connector in FIG. 5;

FIG. 41 is a partial enlarged view of circle part L in FIG. 40;

FIG. 42 is a partially exploded view of the cable connector;

FIG. 43 is a partially exploded view of FIG. 42 from another angle;

FIG. 44 is a further partially exploded view of FIG. 42;

FIG. 45 is a partially exploded view of FIG. 44 from another angle;

FIG. 46 is a perspective exploded view of a cable module and a metal shield enclosure in FIG. 44;

FIG. 47 is a perspective exploded view of FIG. 46 from another angle;

FIG. 48 is a perspective view of a plurality of cable conductive terminals of the cable connector;

FIG. 49 is a perspective view of FIG. 48 from another angle;

FIG. 50 is a perspective schematic view of FIG. 48 from another angle;

FIG. 51 is a top view of FIG. 50;

FIG. 52 is a perspective schematic view of the electrical connector in accordance with a third embodiment of the present disclosure;

FIG. 53 is a perspective schematic view of FIG. 52 from another angle;

FIG. 54 is a partial enlarged view of circle part P in FIG. 53;

FIG. 55 is a partially exploded view of FIG. 52;

FIG. 56 is a partial enlarged view of circle part Q in FIG. 55;

FIG. 57 is a partially exploded view of FIG. 55 from another angle;

FIG. 58 is a partially exploded view of FIG. 53;

FIG. 59 is a partially exploded view of FIG. 58 from another angle;

FIG. 60 is a perspective view of a shielding module in FIG. 55;

FIG. 61 is a perspective schematic view of FIG. 60 from another angle;

FIG. 62 is a partially exploded view of FIG. 60;

FIG. 63 is a partially exploded view of FIG. 62 from another angle; and

FIG. 64 is a cross-sectional view taken along line R-R in FIG. 52.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

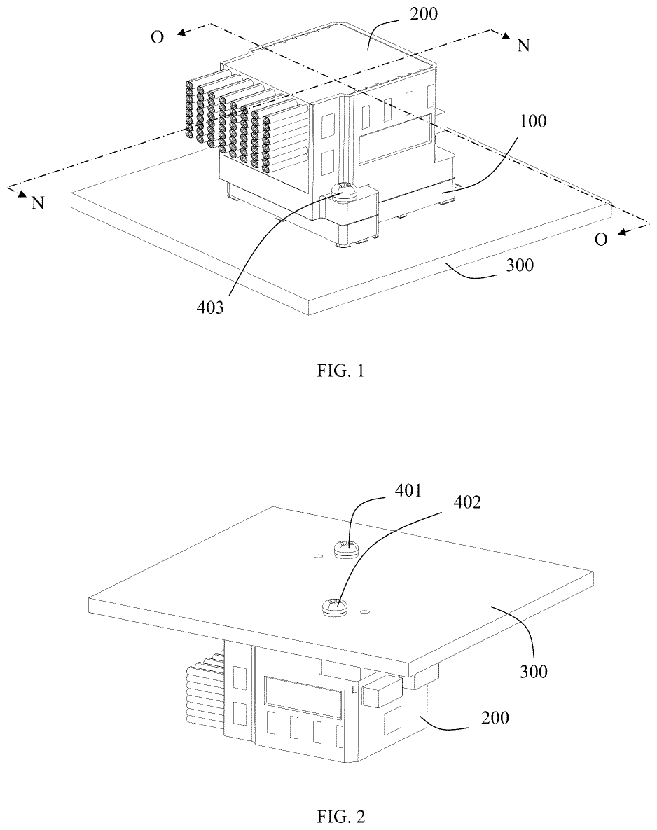

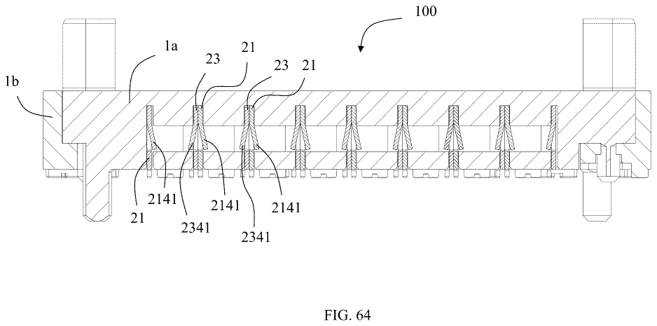

Referring to FIG. 1 to FIG. 64, the present disclosure discloses a connector assembly, including a circuit board 300, an electrical connector 100 mounted to the circuit board 300, and a mating connector configured to mate with the electrical connector 100. In the illustrated embodiment of the present disclosure, the electrical connector 100 is a board-end backplane connector. The mating connector is a cable connector 200, for example a cable-end backplane connector. Of course, it is understandable to those skilled in the art that in other embodiments of the present disclosure, the types of the electrical connector 100 and the mating connector may be flexibly adjusted as needed. The mating connector mates with the electrical connector 100 along a mating direction to achieve data transmission.

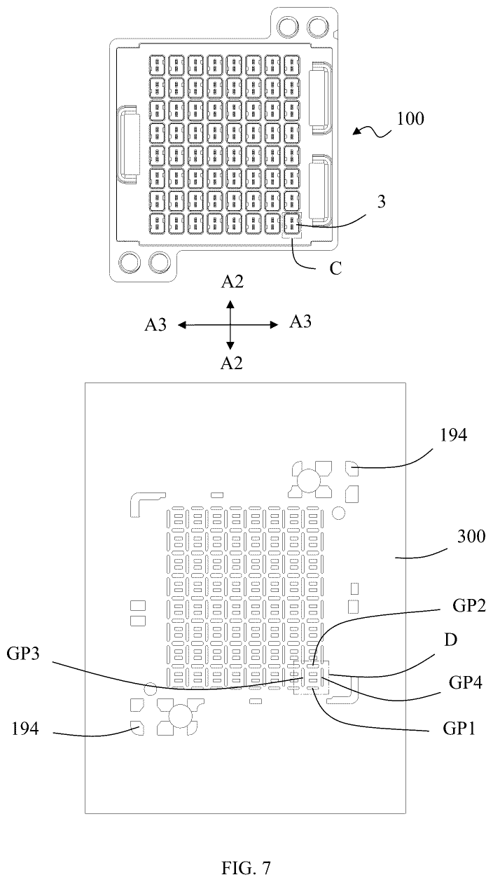

Referring to FIG. 7 and FIG. 9, the circuit board 300 includes a plurality of conductive pads located on its surface (for example, an upper surface). The plurality of conductive pads are divided into several groups and are arranged in a matrix in a second direction A2-A2 (for example, a left-right direction) and a third direction A3-A3 (for example, a front-rear direction). Each group of conductive pads includes a first ground conductive pad GP1, a second ground conductive pad GP2, a third ground conductive pad GP3, a fourth ground conductive pad GP4, a first signal conductive pad SP1, and a second signal conductive pad SP2. In the illustrated embodiment of the present disclosure, the first ground conductive pad GP1, the second ground conductive pad GP2, the third ground conductive pad GP3 and the fourth ground conductive pad GP4 are generally enclosed to form a frame. Any two adjacent ground conductive pads of the first ground conductive pad GP1, the second ground conductive pad GP2, the third ground conductive pad GP3 and the fourth ground conductive pad GP4 are all arranged separately. That is, any two adjacent ground conductive pads of the first ground conductive pad GP1, the second ground conductive pad GP2, the third ground conductive pad GP3 and the fourth ground conductive pad GP4 are disconnected. The first signal conductive pad SP1 and the second signal conductive pad SP2 are located in the frame and are surrounded by the first ground conductive pad GP1, the second ground conductive pad GP2, the third ground conductive pad GP3 and the fourth ground conductive pad GP4 in order to improve the shielding effect and improve the quality of signal transmission. In one embodiment of the present disclosure, the first signal conductive pad SP1 and the second signal conductive pad SP2 form a differential pair to increase the rate of signal transmission. In the illustrated embodiment of the present disclosure, the two adjacent groups of conductive pads share one ground conductive pad. As for any group of first signal conductive pad SP1 and second signal conductive pad SP2, one first ground conductive pad GP1, one second ground conductive pad GP2, one third ground conductive pad GP3 and one fourth ground conductive pad GP4 are provided around them to ensure a good shielding effect.

Referring to FIG. 2, in the illustrated embodiment of the present disclosure, the connector assembly includes a plurality of fasteners that secure the electrical connector 100 to the circuit board 300. The fasteners include a first screw 401 and a second screw 402. The first screw 401 passes through the circuit board 300 and is fixed in the electrical connector 100. The second screw 402 passes through the circuit board 300 and is fixed in the electrical connector 100.

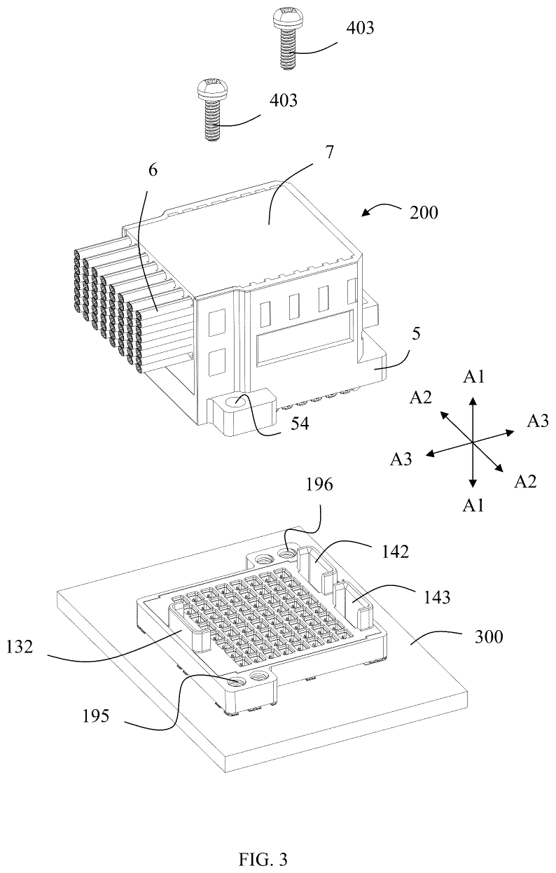

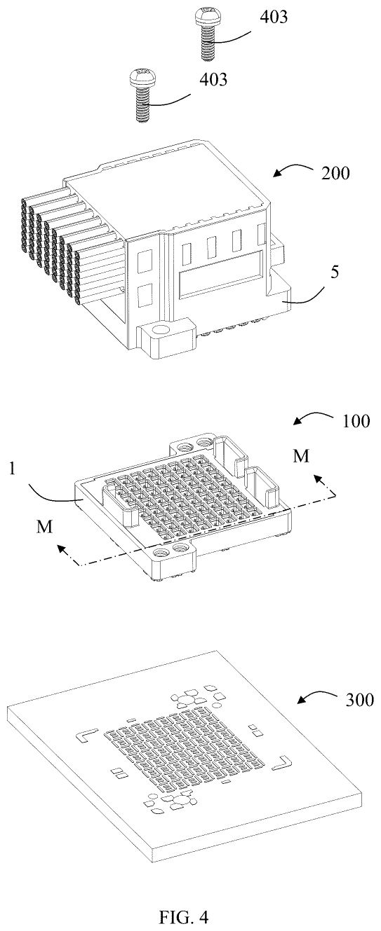

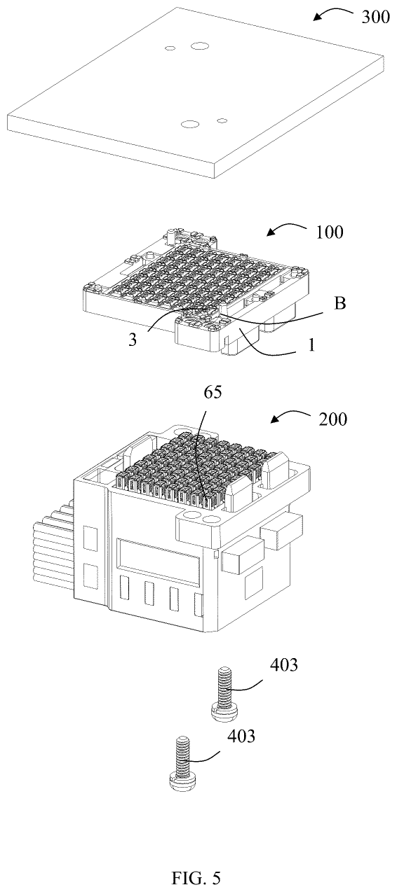

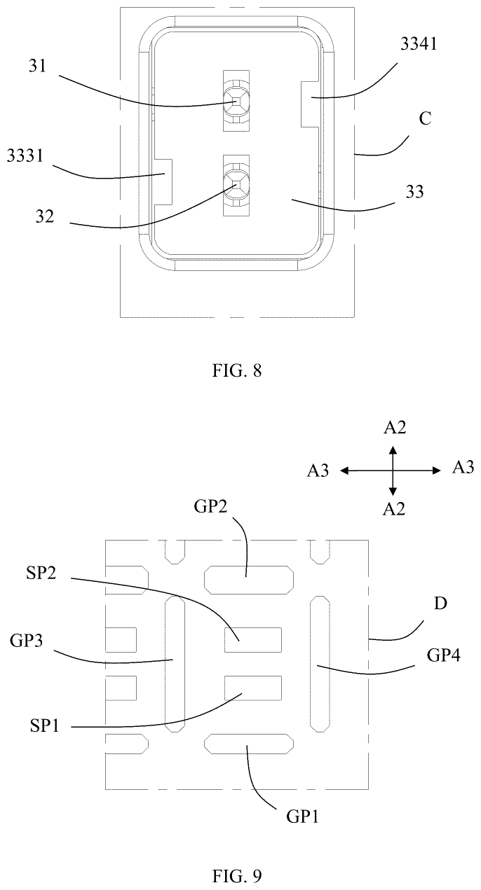

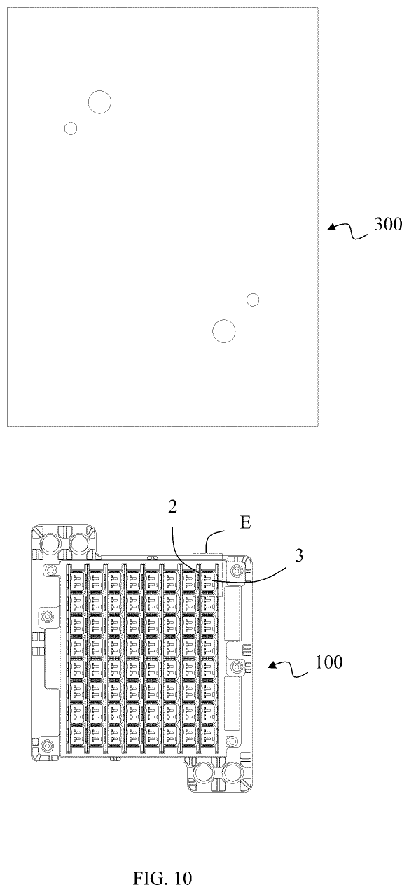

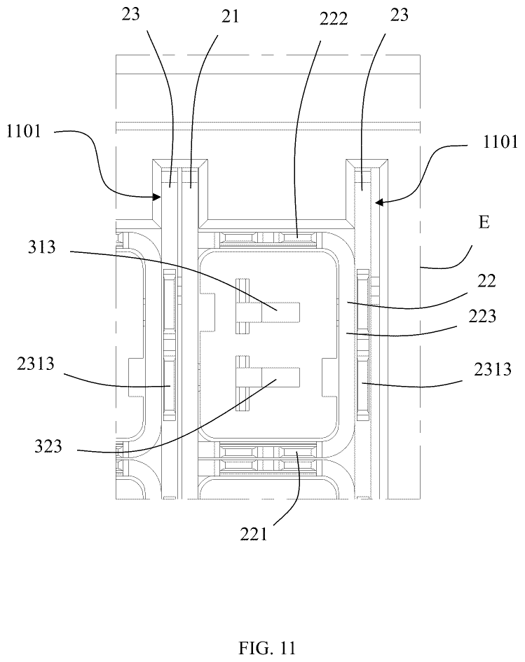

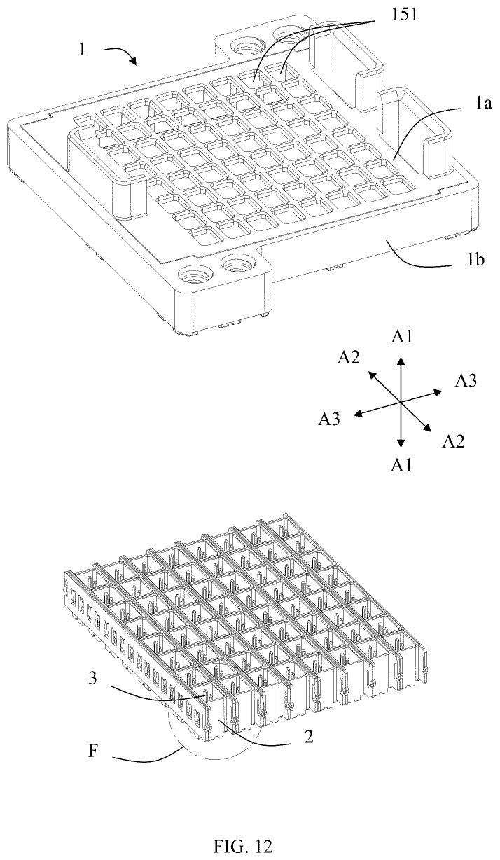

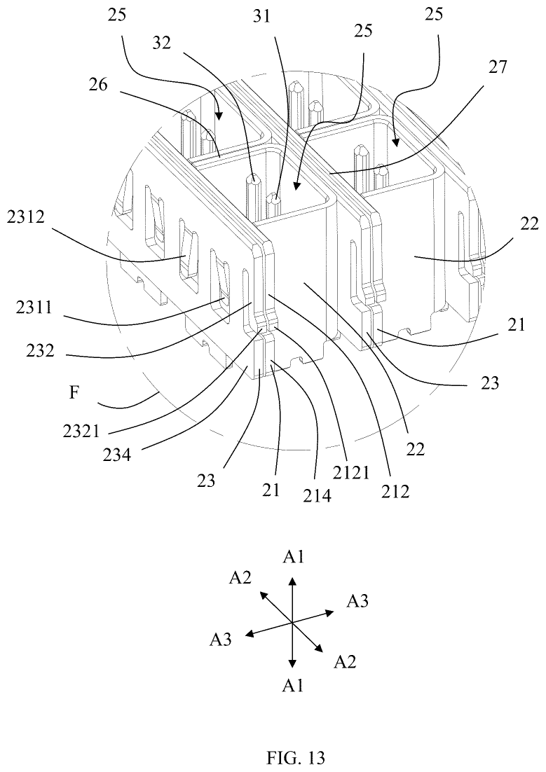

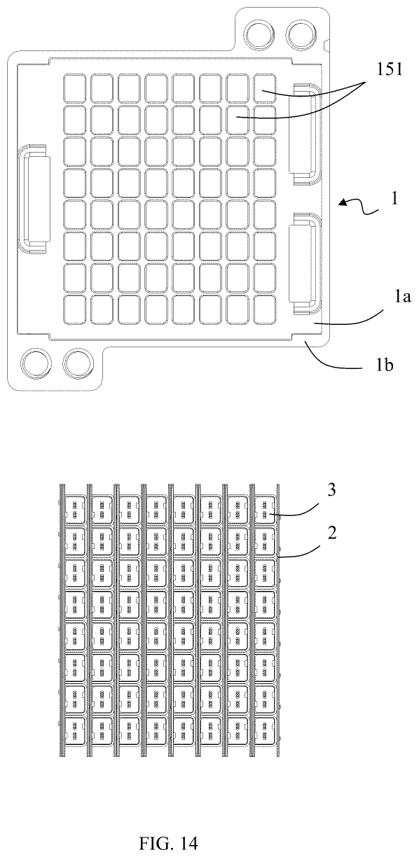

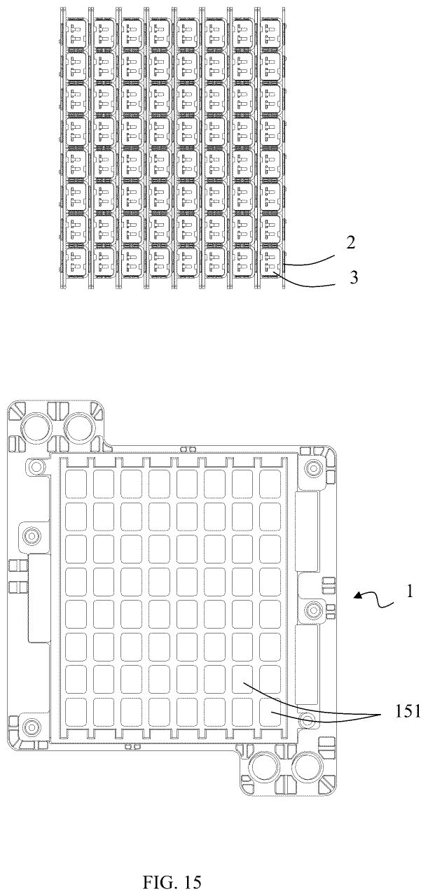

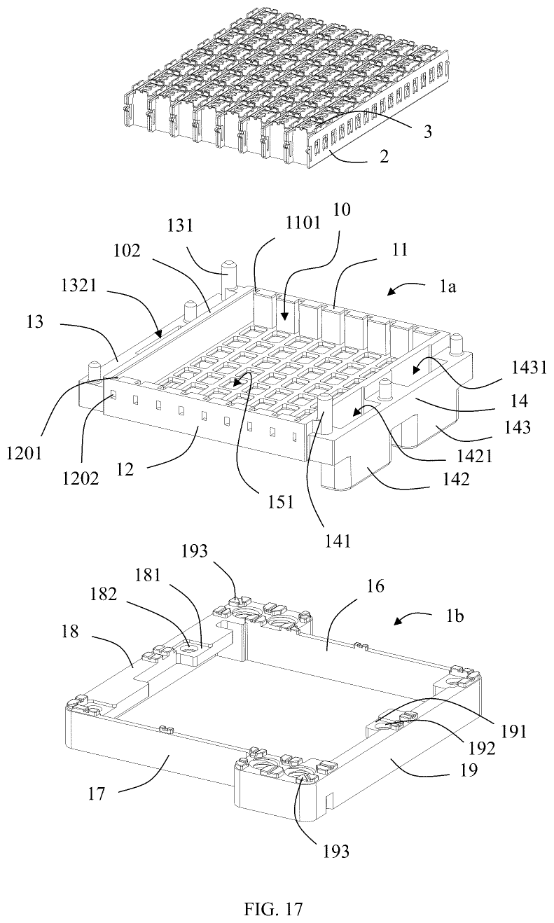

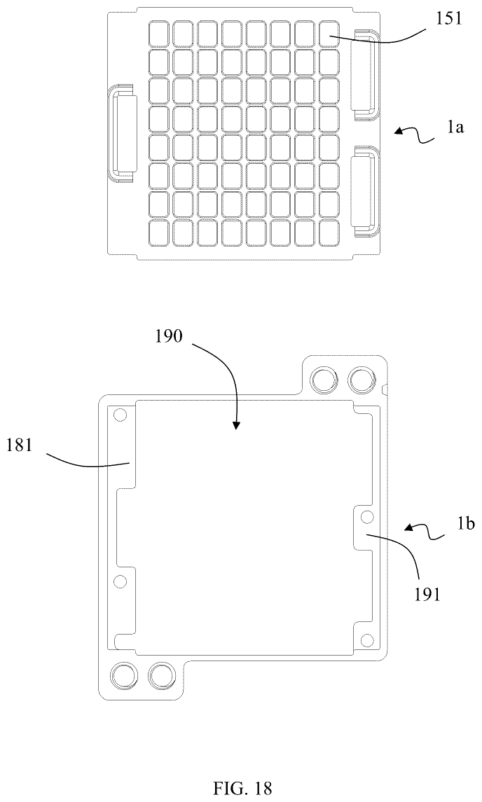

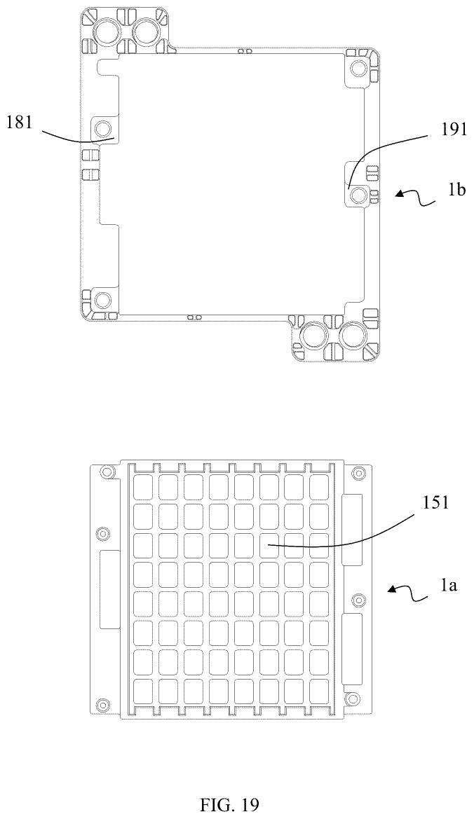

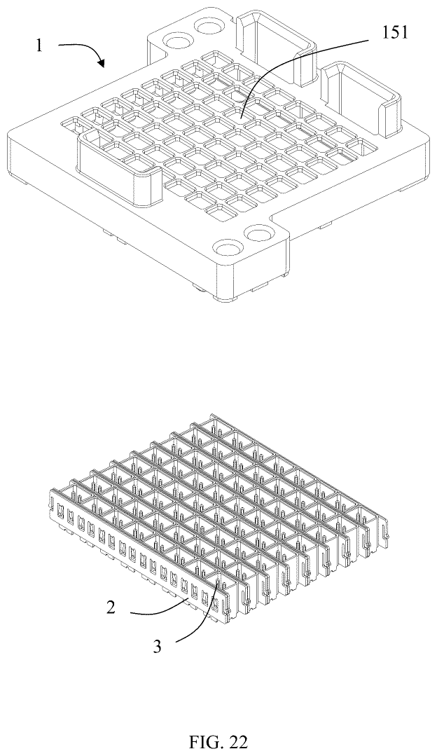

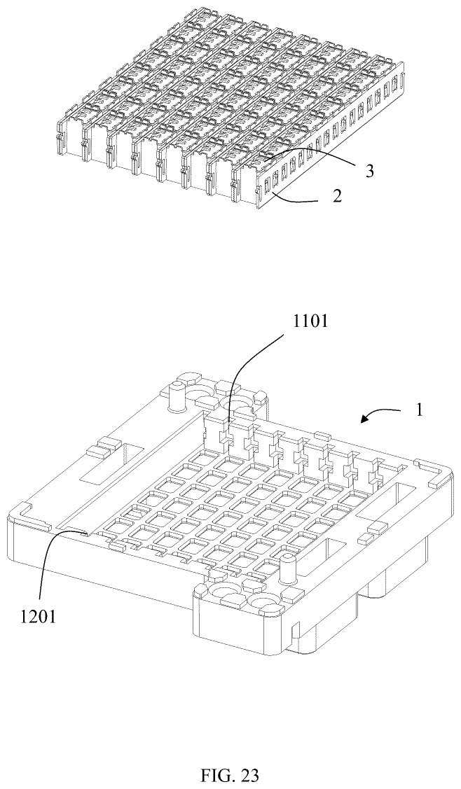

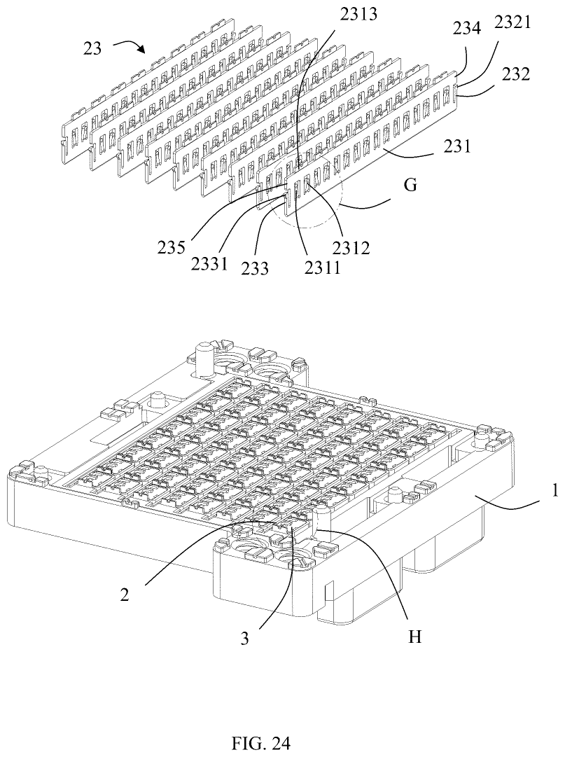

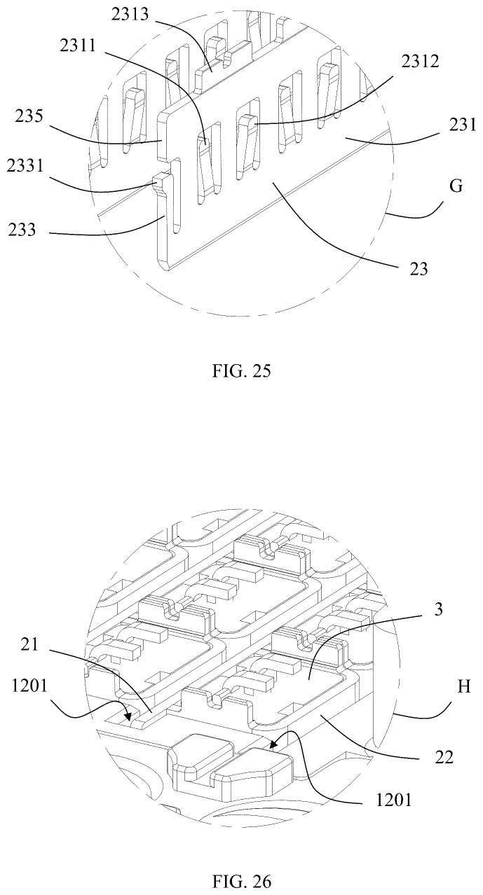

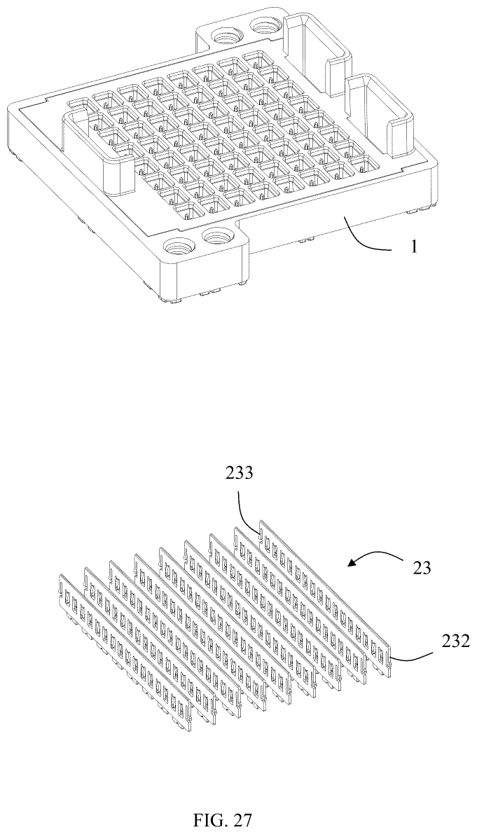

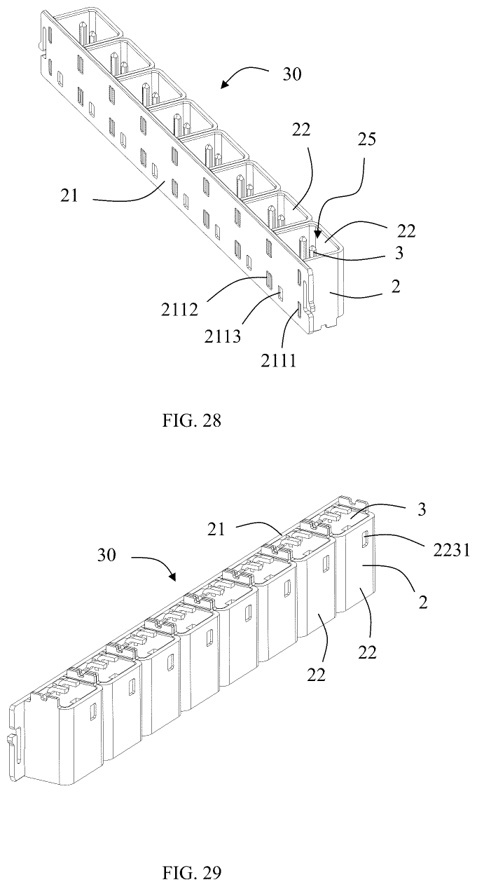

Referring to FIG. 3 to FIG. 23, in the illustrated embodiment of the present disclosure, the electrical connector 100 includes a mounting frame 1 and a plurality of shielding modules 30 mounted to the mounting frame 1. Each shielding module 30 includes a shielding assembly 2, and a plurality of terminal modules 3 mounted to the shielding assembly 2.

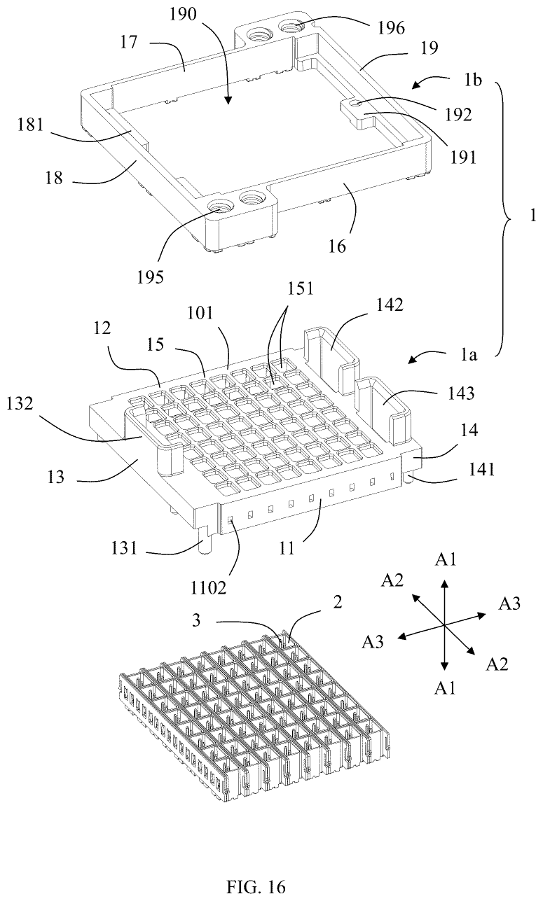

Referring to FIG. 16 to FIG. 19, in the first embodiment of the present disclosure, the mounting frame 1 includes an inner frame 1a and an outer frame 1b. The inner frame 1a and the outer frame 1b are provided separately, and the inner frame 1a is disposed in the outer frame 1b. In one embodiment of the present disclosure, the inner frame 1a is an insulating inner frame, i.e., it is made of an insulating material. The outer frame 1b is a conductive outer frame. Specifically, in one embodiment of the present disclosure, the outer frame 1b is a metal outer frame, that is, the outer frame 1b is made of a metal material to improve shielding performance. Of course, in other embodiments, the inner frame 1a may also be a metal inner frame, or both the inner frame 1a and the outer frame 1b are metal frames. In one embodiment of the present disclosure, the inner frame 1a is fixed in the outer frame 1b in an interference fit manner.

In the first embodiment of the present disclosure, the inner frame 1a includes a base plate portion 15, a first wall portion 11 connected to the base plate portion 15 and located on a first side of the base plate portion 15, a second wall portion 12 connected to the base plate portion 15 and located on a second side of the base plate portion 15, a third wall portion 13 connected to the base plate portion 15 and located on a third side of the base plate portion 15, and a fourth wall portion 14 connected to the base plate portion 15 and is located on a fourth side of the base plate portion 15. In the first embodiment of the present disclosure, the first wall portion 11, the second wall portion 12, the third wall portion 13 and the fourth wall portion 14 are located around the base plate portion 15. The first wall portion 11 is disposed opposite to the second wall portion 12. The third wall portion 13 is disposed opposite to the fourth wall portion 14. The first wall portion 11, the second wall portion 12, the third wall portion 13 and the fourth wall portion 14 are surrounded by a rectangle to form a mounting space 10. The base plate portion 15 is located above the mounting space 10. In the first embodiment of the present disclosure, the first wall portion 11, the second wall portion 12, the third wall portion 13 and the fourth wall portion 14 are provided with a mating surface 101 (for example, an upper surface), and a mounting surface 102 (for example, a lower surface) disposed opposite to the mating surface 101.

In the first embodiment of the present disclosure, the base plate portion 15 defines a plurality of module receiving holes 151 extending through the base plate portion 15 in a first direction A1-A1 (for example, a top-bottom direction). Each module receiving hole 151 is generally rectangular. The plurality of module receiving holes 151 are arranged in a grid pattern along the second direction A2-A2 and the third direction A3-A3. In the illustrated embodiment of the present disclosure, the module receiving holes 151 are arranged in a matrix in the second direction A2-A2 and the third direction A3-A3. Each module receiving hole 151 is in communication with the mounting space 10. It is understandable to those skilled in the art that the technical term “matrix” used in the present disclosure should be understood in a broad sense, that is, it should include arrangements not in rows and columns due to process or slight deformation, etc. By providing the module receiving holes 151 on the mounting frame 1, the present disclosure is beneficial to improve the position accuracy of the module receiving holes 151, thereby improving the mating accuracy when it is mated with the cable connector 200. In the illustrated embodiment of the present disclosure, each module receiving hole 151 is a circumferentially enclosed hole to ensure the structural strength of the mounting frame 1 as much as possible.

In the first embodiment of the present disclosure, the third wall portion 13 is further provided with a plurality of first mounting posts 131 protruding downwardly along the first direction A1-A1, and a first positioning protrusion 132 protruding upwardly along the first direction A1-A1. The first mounting protrusion post 131 is opposite to a protruding direction of the first positioning protrusion 132. Specifically, in the first embodiment of the present disclosure, the first positioning protrusion 132 is generally U-shaped, and includes a first guide groove 1321 extending through the third wall portion 13 along the first direction A1-A1.

The fourth wall portion 14 is provided with a plurality of second mounting posts 141 protruding downwardly along the first direction A1-A1, and a second positioning protrusion 142 and a third positioning protrusion 143 that protrude upwardly along the first direction A1-A1. The second mounting post 141 is opposite to protruding directions of the second positioning protrusion 142 and the third positioning protrusion 143. In the first embodiment of the present disclosure, the second positioning protrusion 142 is generally U-shaped, and includes a second guide groove 1421 extending through the fourth wall portion 14 along the first direction A1-A1. Similarly, the third positioning protrusion 143 is also generally U-shaped, including a third guide groove 1431 extending through the fourth wall portion 14 along the first direction A1-A1. It is understandable to those of ordinary skill in the art that by providing the first positioning protrusion 132 on the third wall portion 13, and the second positioning protrusion 142 and the third positioning protrusion 143 on the fourth wall portion 14, it can play a fool-proof role and ensure the correctness when cooperating with the cable connector 200. The first positioning protrusion 132, the second positioning protrusion 142 and the third positioning protrusion 143 all protrude upwardly beyond the mating surface 101. The first mounting posts 131 and the second mounting posts 141 protrude downwardly beyond the mounting surface 102. In the first embodiment of the present disclosure, the first mounting posts 131 and the second mounting posts 141 are configured to cooperate with the outer frame 1b.

In the first embodiment of the present disclosure, the inner side of the first wall portion 11 further defines a plurality of first mounting grooves 1101 that extend downwardly through the mounting surface 102 along the first direction A1-A1, and a plurality of first locking holes 1102 in communication with the first mounting grooves 1101 and recessed outwardly. The first mounting grooves 1101 are exposed to the mounting space 10 and in communication with the mounting space 10. Each first mounting groove 1101 does not extend through the mating surface 101 upwardly along the first direction A1-A1 in order to ensure the structural strength of the first wall portion 11 as much as possible. In the first embodiment of the present disclosure, the first locking holes 1102 extend through the first wall portion 11 along the second direction A2-A2. The first locking holes 1102 are arranged at intervals along the third direction A3-A3, and each first locking hole 1102 is a circumferentially closed hole to ensure the structural strength of the first wall portion 11 as much as possible.

Similarly, the inner side of the second wall portion 12 further defines a plurality of second mounting grooves 1201 that extend downwardly through the mounting surface 102 along the first direction A1-A1, and a plurality of second locking holes 1202 in communication with the second mounting grooves 1201 and concaved outwardly. The second mounting grooves 1201 are exposed to the mounting space 10 and in communication with the mounting space 10. Each second mounting groove 1201 does not extend through the mating surface 101 upwardly along the first direction A1-A1 to ensure the structural strength of the second wall portion 12 as much as possible. In the first embodiment of the present disclosure, the second locking holes 1202 extend through the second wall portion 12 along the second direction A2-A2. The second locking holes 1202 are arranged at intervals along the third direction A3-A3, and each second locking hole 1202 is a circumferentially closed hole to ensure the structural strength of the second wall portion 12 as much as possible.

In the first embodiment of the present disclosure, the first mounting grooves 1101 do not extend through the first wall portion 11 laterally outward. The second mounting grooves 1201 do not extend through the second wall portion 12 laterally outward. With this arrangement, the present disclosure is able to reduce openings as much as possible, improve the shielding effect, and improve the quality of signal transmission. In the first embodiment of the present disclosure, the first mounting groove 1101 and the second mounting groove 1201 aligned with each other are arranged to hold a shielding shell assembly 2 (described in detail later).

In the first embodiment of the present disclosure, the outer frame 1b is generally frame-shaped, and includes a first outer frame wall 16, a second outer frame wall 17 disposed opposite to the first outer frame wall 16, a third outer frame wall 18 connecting one end of the first outer frame wall 16 and one end of the second outer frame wall 17, a fourth outer frame wall 19 connecting another end of the first outer frame wall 16 and another end of the second outer frame wall 17, and an accommodating cavity 190 surrounded by the first outer frame wall 16, the second outer frame wall 17, the third outer frame wall 18, and the fourth outer frame wall 19. The accommodating cavity 190 is configured to at least partially accommodate the inner frame 1a. The first outer frame wall 16 corresponds to the first wall portion 11. The second outer frame wall 17 corresponds to the second wall portion 12. The third outer frame wall 18 corresponds to the third wall portion 13. The fourth outer frame wall 19 corresponds to the fourth wall portion 14.

In the first embodiment of the present disclosure, the third outer frame wall 18 is provided with a first limiting protrusion 181 protruding into the accommodating cavity 190. The first limiting protrusion 181 defines a first mounting through-hole 182. The first limiting protrusion 181 is configured to abut against the inner frame 1a along the first direction A1-A1 to support the inner frame 1a and to limit the inner frame 1a. At least part of the first mounting post 131 is inserted and passes through the first mounting through-hole 182 for positioning with the circuit board 300.

Similarly, in the first embodiment of the present disclosure, the fourth outer frame wall 19 is provided with a second limiting protrusion 191 protruding into the accommodating cavity 190. The second limiting protrusion 191 defines a second mounting through-hole 192. The second limiting protrusion 191 is configured to abut against the inner frame 1a in the first direction A1-A1 to support the inner frame 1a and to limit the inner frame 1a. At least part of the second mounting post 141 is inserted and passes through the second mounting through-hole 192 for positioning with the circuit board 300.

In one embodiment of the present disclosure, when the inner frame 1a is made of an insulating material, at least a portion of the first mounting post 131 is inserted into the first mounting through-hole 182, and at least part of the second mounting post 141 is inserted into the second mounting through-hole 192. At this time, by means of hot melting and other processes, the first mounting post 131 and the second mounting post 141 can be melted, thereby being better fixed with the outer frame 1b.

In addition, in the illustration embodiment of the present disclosure, the first outer frame wall 16, the second outer frame wall 17, the third outer frame wall 18, and the fourth outer frame wall 19 are all provided with a plurality mounting protrusions 193 that protrude downwardly beyond the mounting surface 102 along the first direction A1-A1. The mounting protrusions 193 are configured to support the circuit board 300 so that a gap is provided between the mounting surface 102 and the upper surface of the circuit board 300 to facilitate heat dissipation. In the first embodiment of the present disclosure, a plurality of thin films 194 are provided on the mounting protrusions 193. Each film 194 is sandwiched between the mounting protrusion 193 and the circuit board 300 to reduce the risk of damage to the circuit board 300.

Besides, the outer frame 1b also includes a first mounting through hole 195 located in one corner thereof, and a second mounting through hole 196 located in another corner thereof. In the illustrated embodiment of the present disclosure, the corner where the first mounting through hole 195 is located and the corner where the second mounting through hole 196 is located is approximately two corners diagonally on the outer frame 1b. In the illustrated embodiment of the present disclosure, the first mounting through hole 195 and the second mounting through hole 196 are threaded holes. When the outer frame 1b is made of a metal material, the threaded hole is provided to ensure the reliability of tightening, improve the convenience of installation, and help reduce the height.

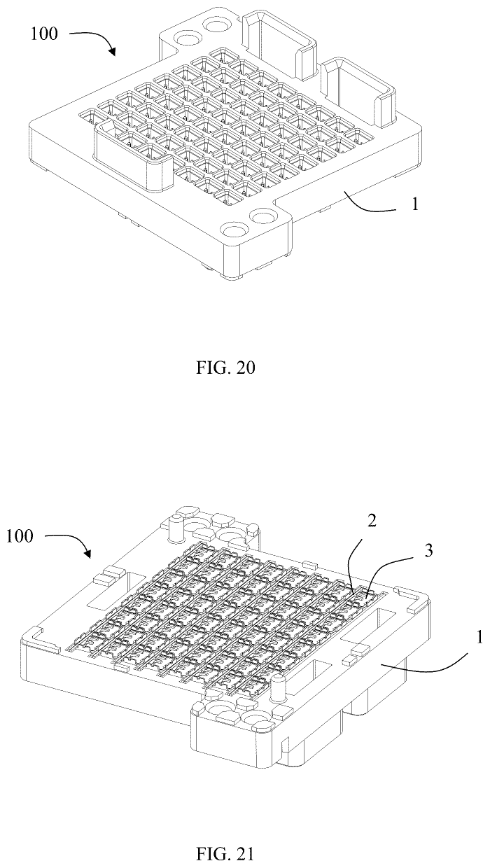

Referring to FIG. 20 to FIG. 23, in a second embodiment of the present disclosure, the mounting frame 1 is of a one-piece configuration, that is, the inner frame 1a and the outer frame 1b in the first embodiment are combined as a whole. In the second embodiment of the present disclosure, the mounting frame 1 is a conductive frame. Specifically, the mounting frame 1 is a metal outer frame, i.e., the mounting frame 1 is made of a metal material to improve shielding performance. Other structures of the mounting frame 1 in the second embodiment of the present disclosure can be referred to the mounting frame 1 in the first embodiment of the present disclosure, which will not be described in detail in the present disclosure. At this time, the mounting frame 1 can be manufactured by a metal powder sintering process.

In the illustrated embodiment of the present disclosure, the shielding shell assembly 2 includes a shielding side plate 21 and a plurality of shielding pieces 22 fastened to the shielding side plate 21. In the illustrated embodiment of the present disclosure, the shielding side plate 21 and the shielding pieces 22 are made of metal material to improve the shielding effect. The shielding side plate 21 includes a plate body portion 211, a first insertion piece portion 214 located at one end of the plate body portion 211, and a second insertion piece portion 215 located at another end of the plate body portion 211. The first insertion piece portion 214 is provided with a first locking elastic arm 212. The second insertion piece portion 215 is provided with a second locking elastic arm 213. The plate body portion 211 is provided with a plurality of first receiving grooves 2111 arranged at intervals in the first direction A1-A1, a plurality of second receiving grooves 2112 arranged at intervals in the first direction A1-A1, and a plurality of first positioning grooves 2113. The first receiving groove 2111 and the second receiving groove 2112 are arranged parallel to each other. The first positioning groove 2113 is located between the first receiving groove 2111 and the second receiving groove 2112. The first insertion piece portion 214 is received in the first mounting groove 1101. The second insertion piece portion 215 is received in the second mounting groove 1201. The first locking elastic arm 212 is cantilever-shaped and is provided with a first locking protrusion 2121. The second locking elastic arm 213 is cantilever-shaped and is provided with a second locking protrusion 2131. The first locking protrusion 2121 is locked and fixed in the first locking hole 1102, and the second locking protrusion 2131 is locked and fixed in the second locking hole 1202, in order to prevent the shielding shell assembly 2 from disengaging from the mounting frame 1.

In the first embodiment of the present disclosure, each shielding piece 22 is of a U-shaped configuration, including a first surrounding wall 221, a second surrounding wall 222 disposed opposite to the first surrounding wall 221, and a third surrounding wall 223 connected between the first surrounding wall 221 and the second surrounding wall 222. The third surrounding wall 223 is perpendicular to the first surrounding wall 221 and the second surrounding wall 222. The third surrounding wall 223 is disposed opposite to the shielding side plate 21. The first surrounding wall 221 is provided with a plurality of first mounting protrusion tabs 2211 arranged at intervals along the first direction A1-A1. The first mounting protrusion tab 2211 is configured to be inserted in the first receiving groove 2111. The second surrounding wall 222 is provided with a plurality of second mounting protrusion tabs 2221 arranged at intervals along the first direction A1-A1. The second mounting protrusion tab 2221 is configured to be inserted in the second receiving groove 2112. In one embodiment of the present disclosure, in order to increase the holding force between the shielding piece 22 and the shielding side plate 21, the first mounting protrusion tab 2211 and the second mounting protrusion tab 2221 are fixed with the shielding side plate 21 by soldering or welding. The soldering or welding methods include but are not limited to laser welding, brazing, or other welding methods. In addition, the first surrounding wall 221 further includes a first mounting portion 2212 provided on a bottom thereof. The first mounting portion 2212 defines a first groove 2213. The second surrounding wall 222 further includes a second mounting portion 2222 provided on a bottom thereof. The second mounting portion 2222 defines a second groove 2223. The first mounting portion 2212 and the second mounting portion 2222 are configured to be fixed to the first ground conductive pad GP1 and the second ground conductive pad GP2, respectively. The first groove 2213 and the second groove 2223 facilitate filling soldering mater (for example, solder) to improve soldering quality. The third surrounding wall 223 defines a second positioning groove 2231.

In the first embodiment of the present disclosure, the plurality of shielding pieces 22 are arranged along the second direction A2-A2. The first surrounding wall 221 of one of the two adjacent shielding pieces 22 is disposed close to the second surrounding wall 222 of a remaining one of the two adjacent shielding pieces 22. The first mounting protrusion tab 2211 of the first surrounding wall 221 of one of the two adjacent shielding pieces 22 is inserted into a corresponding first receiving groove 2111 or a corresponding second receiving groove 2112 together with the second mounting protrusion tab 2221 of the second surrounding wall 222 of a remaining one of the two adjacent shielding pieces 22. In one embodiment of the present disclosure, the first surrounding wall 221 of one of the two adjacent shielding pieces 22 and the second surrounding wall 222 of a remaining one of the two adjacent shielding pieces 22 are abutted against each other.

In the illustrated embodiment of the present disclosure, the shielding shell assembly 2 further includes a plurality of connecting plates 23. In the first embodiment of the present disclosure, each connecting plate 23 is made of a metal material, which includes a base body portion 231, a first protruding piece portion 234 located at one end of the base body portion 231, and a second protruding piece portion 235 located at another end of the base body portion 231. The first protruding piece portion 234 is provided with a first retaining elastic arm 232. The second protruding piece portion 235 is provided with a second retaining elastic arm 233. The first retaining elastic arm 232 is cantilever-shaped and is provided with a first retaining protrusion 2321. The second retaining elastic arm 233 is cantilever-shaped and is provided with a second retaining protrusion 2331. The first retaining protrusion 2321 is locked and fixed in the first locking hole 1102, and the second retaining protrusion 2331 is locked and fixed in the second locking hole 1202, in order to prevent the connecting plate 23 from disengaging from the mounting frame 1.

In the illustrated embodiment of the present disclosure, the base body portion 231 is further provided with a plurality of first abutting elastic arms 2311 and a plurality of second abutting elastic arms 2312. The first abutting elastic arms 2311 and the second abutting elastic arms 2312 are formed by stamping outward from the base body portion 231. The first abutting elastic arm 2311 protrudes beyond a first side of the base body portion 231. The second abutting elastic arm 2312 protrudes beyond a second side of the base body portion 231. The first abutting elastic arm 2311 and the second abutting elastic arm 2312 have opposite protruding directions. In the illustrated embodiment of the present disclosure, the first abutting elastic arms 2311 and the second abutting elastic arms 2312 are arranged alternately. The first abutting elastic arms 2311 abut against adjacent shielding side plate 21. The second abutting elastic arms 2312 abut against adjacent shielding pieces 22. As a result, the connecting plate 23 is able to connect two adjacent shielding shell assemblies 2 to improve the ground shielding effect. It is understandable to those skilled in the art that the connecting plate 23 located on the outermost side of the shielding shell assembly 2, its second abutting elastic arm 2312 abuts against the inner frame 1a. When the inner frame 1a is made of a metal material, the above abutment is conducive to connecting the outermost connecting plate 23 with the inner frame 1a as a whole, thereby facilitating the shielding effect.

In the first embodiment of the present disclosure, the base body portion 231 is further provided with a plurality of mounting tails 2313 that protrude downwardly beyond the mounting surface 102 along the first direction A1-A1. The mounting tail 2313 is perpendicular to the first mounting portion 2212 and the second mounting portion 2222. The mounting tail 2313 defines a ventilation groove 2314. In two adjacent shielding shell assemblies 2, a mounting tail 2313 of one shielding shell assembly 2 is configured to be fixed to the third ground conductive pad GP3 of the circuit board 300 by soldering or welding, and the mounting tail 2313 of the other shielding shell assembly 2 is configured to be fixed to the fourth ground conductive pad GP4 of the circuit board 300 by soldering or welding. In the two adjacent shielding shell assemblies 2, the mounting tail 2313 of one shielding shell assembly 2, the mounting tail 2313 of the other shielding shell assembly 2, the first mounting portion 2212 and the second mounting portion 2222 jointly form a shielding space 24. Preferably, a bottom surface of the mounting tail 2313 of one shielding shell assembly 2, a bottom surface of the mounting tail 2313 of the other shielding shell assembly 2, a bottom surface of the first mounting portion 2212 and a bottom surface of the second mounting portion 2222 are located in a same plane for being fixed to the circuit board 300 by soldering or welding. In addition, in the illustration embodiment of the present disclosure, the first mounting portion 2212, the second mounting portion 2222 and the mounting tail 2313 are all thinned compared to the parts connected thereto, thereby facilitating the improvement of soldering or welding quality.

In the illustrated embodiment of the present disclosure, the shielding piece 22 and the shielding side plate 21 form a rectangular and circumferentially surrounded shielding cavity 25 to accommodate the terminal module 3. By providing the U-shaped shielding pieces 22 to mate with the shielding side plate 21 to form the plurality of shielding cavities 25, the volume of each shielding cavity 25 can be relatively small, thereby facilitating the increase of signal transmission rate. In addition, any two adjacent shielding cavities 25 disposed in the second direction A2-A2 are separated by a first multilayer wall 26 between the two shielding cavities 25, thereby facilitating the improvement of the shielding effect. The first multilayer wall 26 includes the second surrounding wall 222 of one shielding piece 22 and the first surrounding wall 221 of another shielding piece 22. Any two adjacent shielding cavities 25 disposed in the third direction A3-A3 are separated by a second multilayer wall 27 between the two shielding cavities 25, thereby facilitating the improvement of the shielding effect. The second multilayer wall 27 includes the third surrounding wall 223, the connecting plate 23, and the shielding side plate 21.

In one assembly method of the present disclosure, when the shielding shell assembly 2 is assembled with the mounting frame 1, firstly, the terminal module 3 is clamped between the shielding side plate 21 and the shielding piece 22 to form a shielding module 30. Then, the shielding side plate 21 and the shielding piece 22 are fixed. Then, each shielding shell assembly 2 is associated with two connecting plates 23 on two sides thereof, wherein the two adjacent shielding shell assemblies 2 share one connecting plate 23 between them. At this time, the first retaining elastic arm 232 and the first locking elastic arm 212 are attached to each other. The first retaining protrusion 2321 and the first locking protrusion 2121 are abutted against each other for being jointly locked and fixed in the first locking hole 1102. Similarly, the second retaining elastic arm 233 and the second locking elastic arm 213 are abutted against each other. The second retaining protrusion 2331 and the second locking protrusion 2131 are abutted against each other for being jointly locked and fixed in the second locking hole 1202. Then, the shielding shell assembly 2 is installed in the mounting frame 1 together with the terminal module 3. The first insertion piece portion 214 and the first protruding piece portion 234 of the shielding shell assembly 2 are abutted against each other, and are inserted into the first mounting groove 1101 together. The second insertion piece portion 215 and the second protruding piece portion 235 of the shielding shell assembly 2 are abutted against each other, and are inserted into the second mounting groove 1201 together. Of course, it is understandable to those skilled in the art that the connecting plate 23, which is located on the outermost side of the shielding shell assembly 2 and does not abut against the shielding side plate 21, is individually held in one first mounting groove 1101 and one second mounting groove 1201. After assembly is completed, the module receiving holes 151 correspond to the shielding cavities 25.

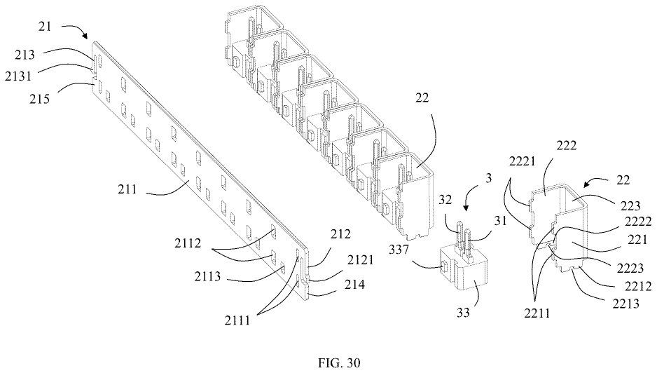

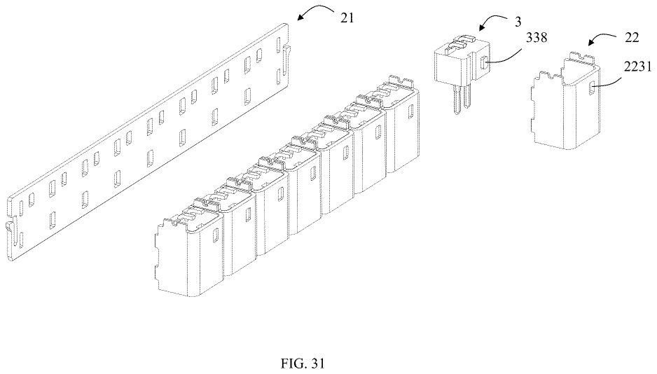

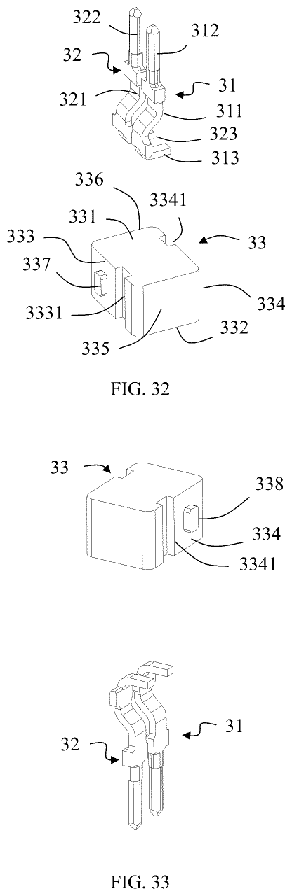

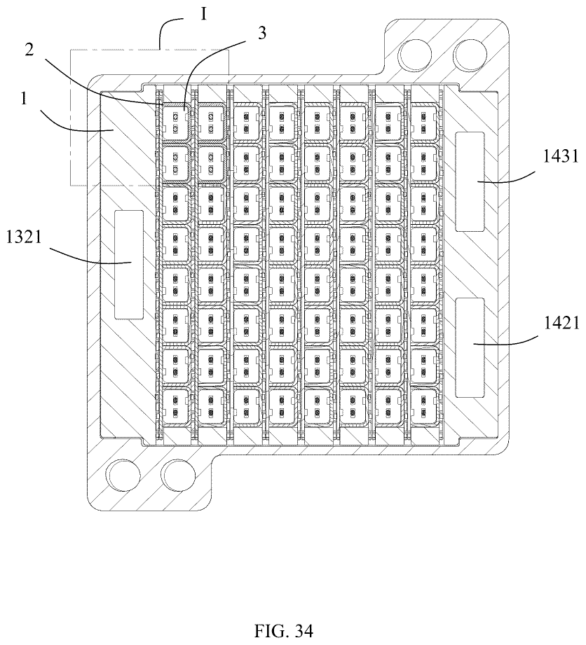

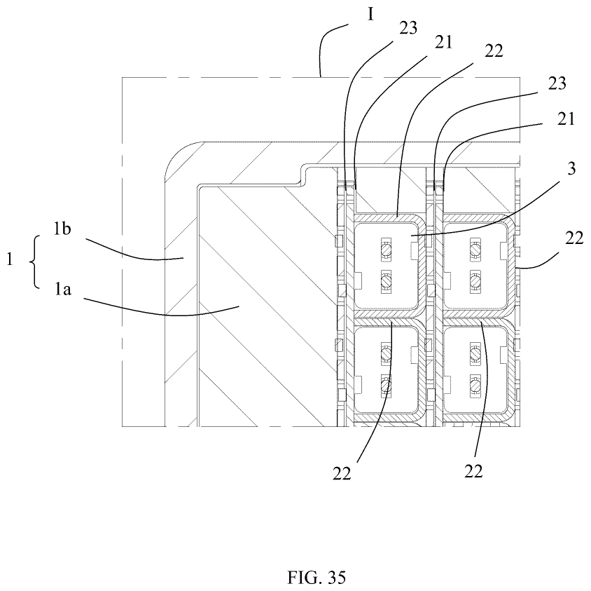

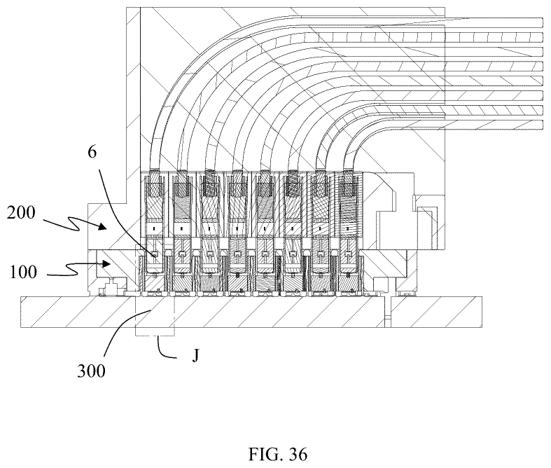

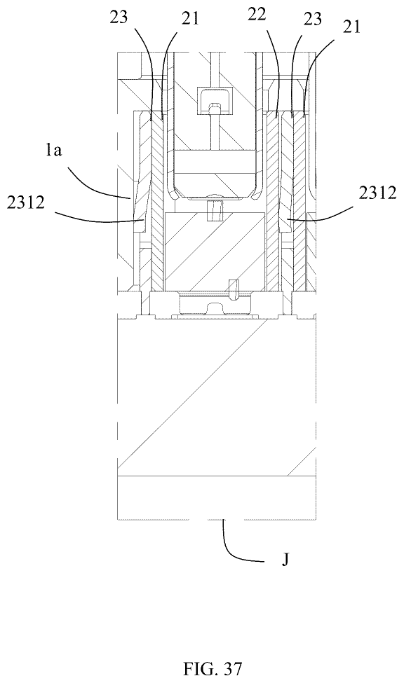

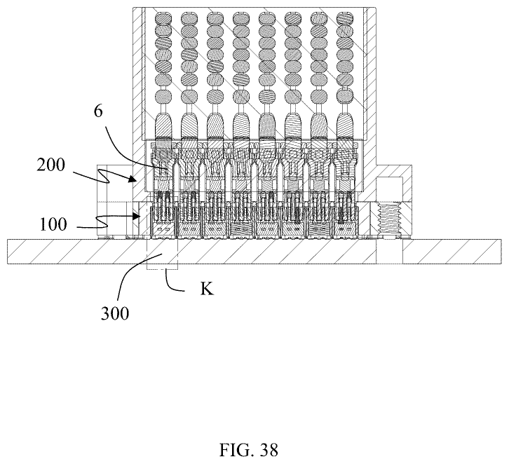

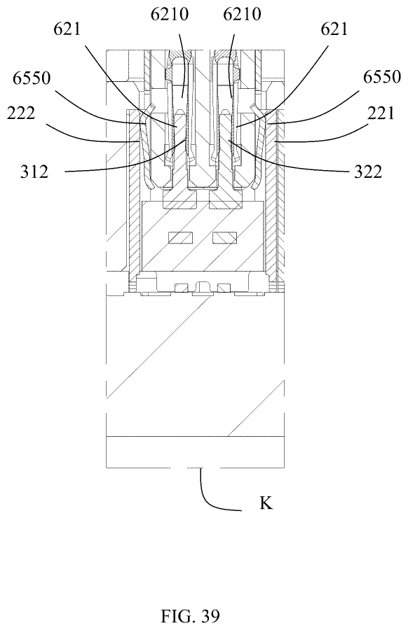

Referring to FIG. 29 to FIG. 33, in the illustrated embodiment of the present disclosure, the plurality of terminal modules 3 are the same. Each terminal module 3 includes an insulating block 33, a first conductive terminal 31 secured to the insulating block 33, and a second conductive terminal 32 secured to the insulating block 33. In one embodiment of the present disclosure, the first conductive terminal 31 and the second conductive terminal 32 are insert-molded with the insulating block 33 to be combined into a whole. Of course, it is understandable to those skilled in the art that in other embodiments of the present disclosure, the first conductive terminal 31 and the second conductive terminal 32 may also be secured to the insulating block 33 by other means (for example, by assembly). In one embodiment of the present disclosure, the first conductive terminal 31 and the second conductive terminal 32 form a differential pair to increase the rate of signal transmission.

The insulating block 33 includes a top surface 331, a bottom surface 332, a first side wall 333, a second side wall 334 disposed opposite to the first side wall 333, a third side wall 335, and a fourth side wall 336 disposed opposite to the third side wall 335.

In the illustrated embodiment of the present disclosure, the first side wall 333 is provided with a first protruding rib 337 protruding outward, and the first protruding rib 337 is configured to be held in the first positioning groove 2113. The second side wall 334 is provided with a second protruding rib 338 protruding outward, and the second protruding rib 338 is configured to be held in the second positioning groove 2231.

In the illustrated embodiment of the present disclosure, the first side wall 333 defines a first through groove 3331 extending through the top surface 331 and the bottom surface 332 in the first direction A1-A1. The second side wall 334 defines a second through groove 3341 extending through the top surface 331 and the bottom surface 332 in the first direction A1-A1. By providing the first through groove 3331 and the second through groove 3341, when the electrical connector 100 goes through a reflow soldering furnace, heat can be transferred to the intermediate area of the electrical connector 100, thereby allowing the entire area to be heated evenly and improving the soldering or welding quality.

The first conductive terminal 31 includes a first fixing portion 311 secured in the insulating block 33, a first contact portion 312 extending from one end of the first fixing portion 311 and protruding upwardly beyond the insulating block 33, and a first tail portion 313 extending from another end of the first fixing portion 311 and protruding downwardly beyond the insulating block 33. In the illustrated embodiment of the present disclosure, the first contact portion 312 is in a needle shape and protrudes into the shielding cavity 25. The first tail portion 313 is substantially in a flat shape and is mounted on the first signal conductive pad SP1 of the circuit board 300 via a surface mounting technology.

Similarly, the second conductive terminal 32 includes a second fixing portion 321 secured in the insulating block 33, a second contact portion 322 extending from one end of the second fixing portion 321 and protruding upwardly beyond the insulating block 33, and a second tail portion 323 extending from another end of the second fixing portion 321 and protruding downwardly beyond the insulating block 33. In the illustrated embodiment of the present disclosure, the second contact portion 322 is in a needle shape and protrudes into the shielding cavity 25. The second tail portion 323 is generally in a flat shape and is mounted on the second signal conductive pad SP2 of the circuit board 300 via a surface mounting technology.

When each terminal module 3 is assembled into the shielding cavity 25 of the shielding shell assembly 2, the terminal module 3 is enclosed by the shielding side plate 21 and the shielding piece 22. The first protruding rib 337 is held in the first positioning groove 2113, and the second protruding rib 338 is held in the second positioning groove 2231. As a result, the first tail portions 313 and the second tail portions 323 of the terminal modules 3 can be controlled in a same plane, which is conducive to improving the yield of the product.

After the electrical connector 100 is assembled, the first mounting portion 2212, the second mounting portion 2222, the mounting tail 2313 of one connecting plate 23, and the mounting tail 2313 of another connecting plate 23 all protrude downwardly beyond the mounting surface 102 along the first direction A1-A1. The first mounting portion 2212, the second mounting portion 2222, the mounting tail 2313 of one connecting plate 23 and the mounting tail 2313 of another connecting plate 23 are fixed to the first ground conductive pad GP1, the second ground conductive pad GP2, the third ground conductive pad GP3 and the fourth ground conductive pad GP4, respectively, by soldering or welding.

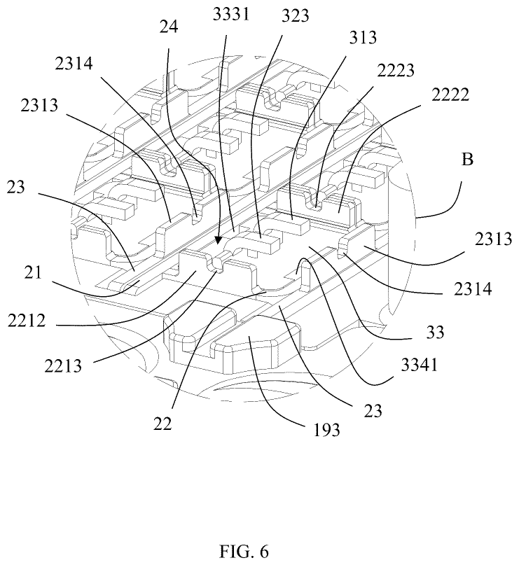

Referring to FIG. 6, the first tail portion 313 and the second tail portion 323 are at least partially located in the shielding space 24. That is, the first tail portion 313 and the second tail portion 323 are surrounded by the first mounting portion 2212, the second mounting portion 2222, the mounting tail 2313 of one connecting plate 23, and the mounting tail 2313 of another connecting plate 23 at a height where it is located, thereby improving the shielding effect of the mounting end.

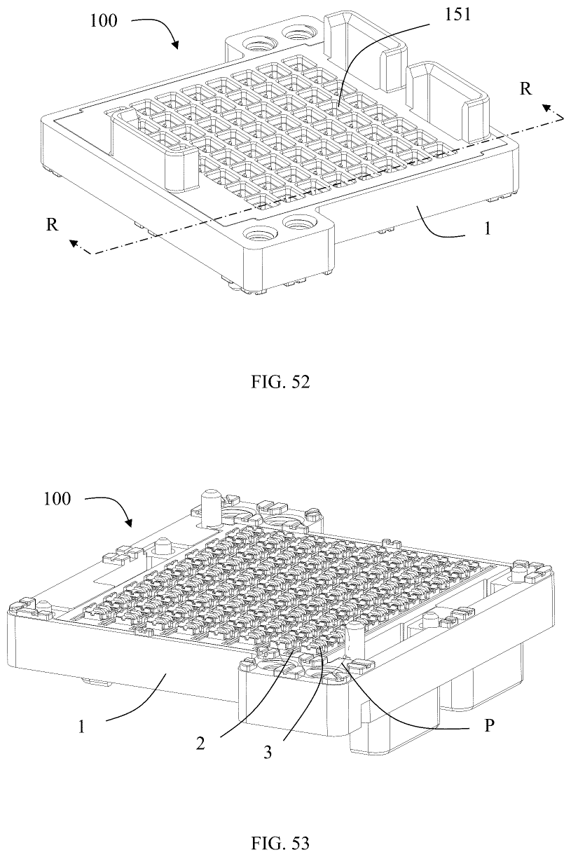

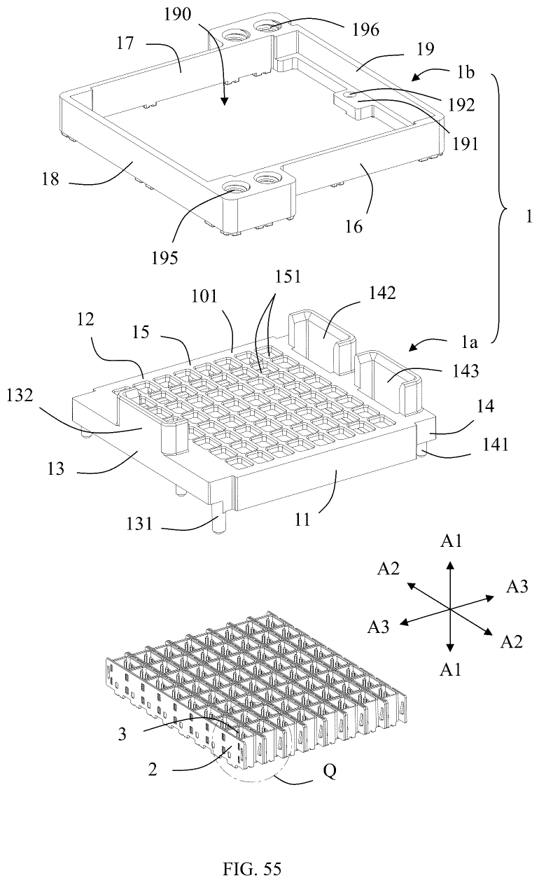

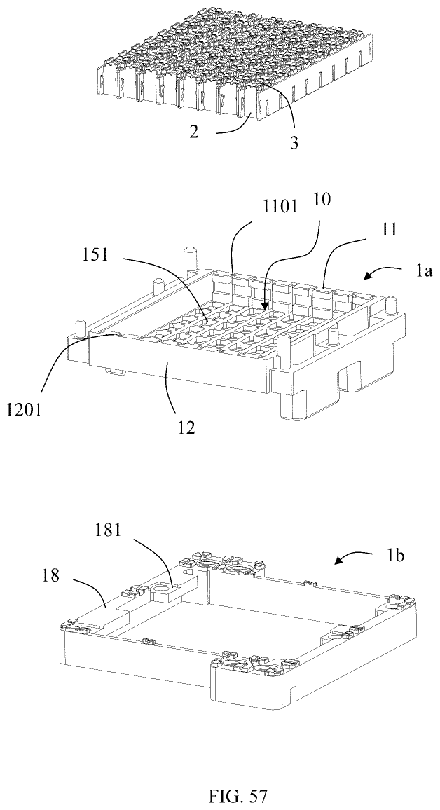

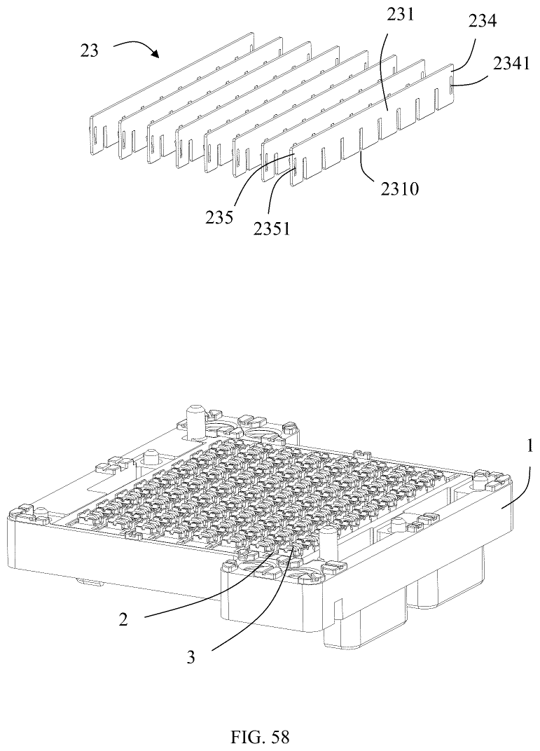

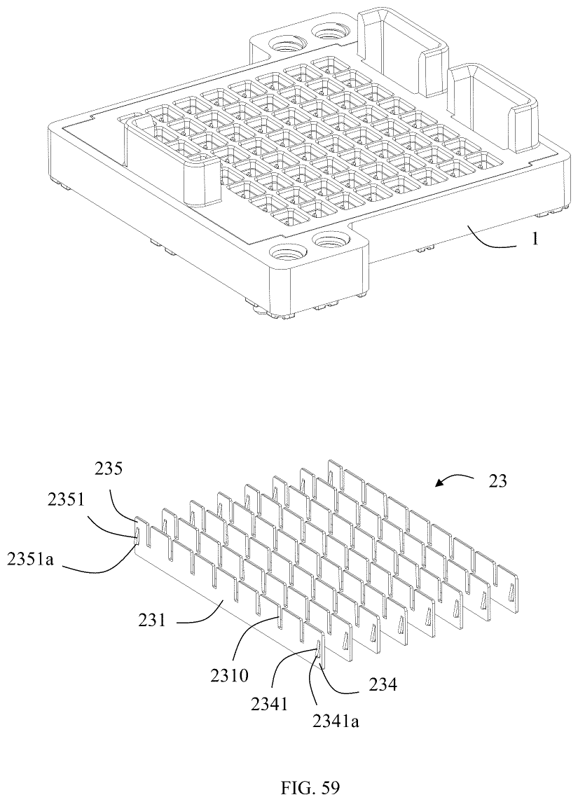

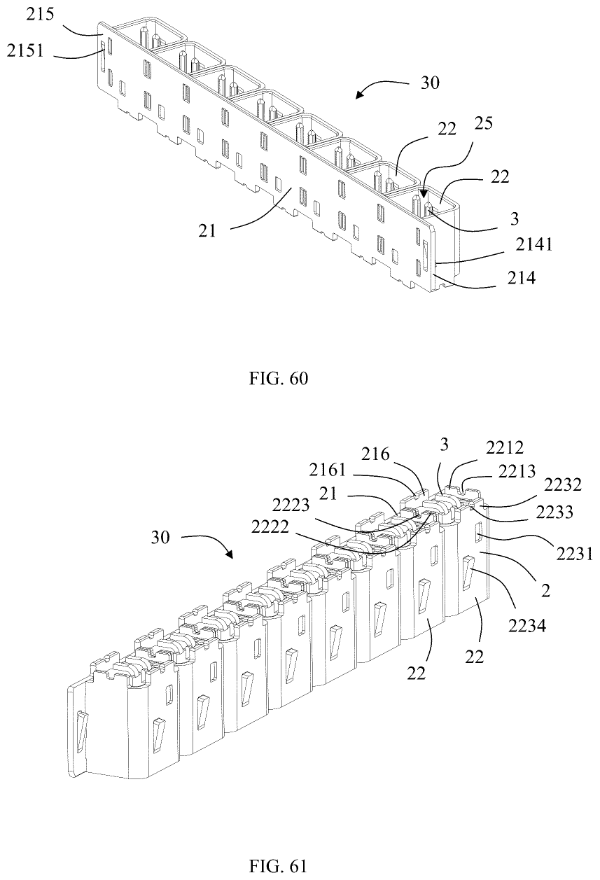

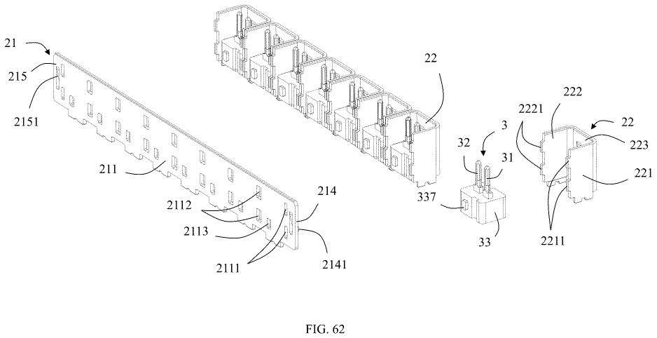

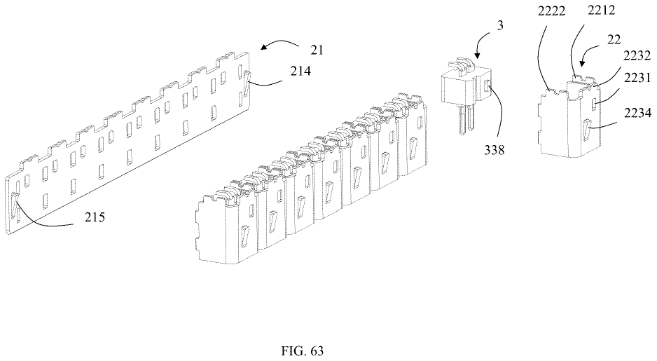

Referring to FIG. 52 to FIG. 64, the electrical connector 100 in a third embodiment of the present disclosure is approximately the same as the electrical connector 100 in the first embodiment of the present disclosure, in which the same reference numerals represent the same or corresponding technical features.

The electrical connector 100 in the third embodiment of the present disclosure includes a mounting frame 1, a shielding shell assembly 2 mounted to the mounting frame 1, and a plurality of terminal modules 3 installed in the shielding shell assembly 2. The mounting frame 1 includes an inner frame 1a and an outer frame 1b. The inner frame 1a and the outer frame 1b are provided separately, and the inner frame 1a is disposed in the outer frame 1b. The mounting frame 1 of the electrical connector 100 in the third embodiment of the present disclosure is the same as the mounting frame 1 of the electrical connector 100 in the first embodiment of the present disclosure, which will not be repeated in the present disclosure. The terminal module 3 of the electrical connector 100 in the third embodiment of the present disclosure is the same as the terminal module 3 of the electrical connector 100 in the first embodiment of the present disclosure, which will not be repeated in the present disclosure.

In the third embodiment of the present disclosure, the shielding shell assembly 2 includes a shielding side plate 21 and a plurality shielding pieces 22 fixed to the shielding side plate 21. In the illustrated third embodiment of the present disclosure, the shielding side plate 21 and the shielding piece 22 are both made of metal material so as to improve the shielding effect. The shielding side plate 21 includes a plate body portion 211, a first insertion piece portion 214 located at one end of the plate body portion 211, a second insertion piece portion 215 located at another end of the plate body portion 211, and a mounting projection portion 216 extending downwardly from the plate body portion 211. The mounting projection portion 216 defines a ventilation groove 2161. The first insertion piece portion 214 is provided with a first fastening elastic arm 2141. The second insertion piece portion 215 is provided with a second fastening elastic arm 2151. The plate body portion 211 is provided with a plurality of first receiving grooves 2111 arranged at intervals in the first direction A1-A1, a plurality of second receiving grooves 2112 arranged at intervals in the first direction A1-A1, and a plurality of first positioning grooves 2113. The first receiving groove 2111 and the second receiving groove 2112 are arranged parallel to each other. The first positioning groove 2113 is located between the first receiving groove 2111 and the second receiving groove 2112. The first insertion piece portion 214 is received in the first mounting groove 1101. The second insertion piece portion 215 is received in the second mounting groove 1201. The first fastening elastic arm 2141 and the second fastening elastic arm 2151 are both inclined, and are stamped sidewardly from the first insertion piece portion 214 and the second insertion piece portion 215, respectively. A first end portion 2141a of the first fastening elastic arm 2141 and a second end portion 2151a of the second fastening elastic arm 2151 are locked in the mounting frame 1 to prevent the shielding shell assembly 2 from disengaging from the mounting frame 1 in a direction opposite to an assembly direction.

In the third embodiment of the present disclosure, each shielding piece 22 is of a U-shaped configuration, including a first surrounding wall 221, a second surrounding wall 222 disposed opposite to the first surrounding wall 221, and a third surrounding wall 223 connected between the first surrounding wall 221 and the second surrounding wall 222. The third surrounding wall 223 is perpendicular to the first surrounding wall 221 and the second surrounding wall 222. The third surrounding wall 223 is disposed opposite to the shielding side plate 21. The first surrounding wall 221 is provided with a plurality of first mounting protrusion tabs 2211 arranged at intervals along the first direction A1-A1. The first mounting protrusion tab 2211 is configured to be inserted in the first receiving groove 2111. The second surrounding wall 222 is provided with a plurality of second mounting protrusion tabs 2221 arranged at intervals along the first direction A1-A1. The second mounting protrusion tab 2221 is configured to be inserted in the second receiving groove 2112. In one embodiment of the present disclosure, in order to increase the holding force between the shielding piece 22 and the shielding side plate 21, the first mounting protrusion tab 2211 and the second mounting protrusion tab 2221 are fixed with the shielding side plate 21 by soldering or welding. The soldering or welding methods include but are not limited to laser welding, brazing, or other welding methods. In addition, the first surrounding wall 221 further includes a first mounting portion 2212 provided on a bottom thereof. The first mounting portion 2212 defines a first groove 2213. The second surrounding wall 222 further includes a second mounting portion 2222 provided on a bottom thereof. The second mounting portion 2222 defines a second groove 2223. The third surrounding wall 223 further includes a third mounting portion 2232 provided on a bottom thereof. The third mounting portion 2232 defines a third groove 2233. The first mounting portion 2212, the second mounting portion 2222, the third mounting portion 2232 and the mounting projection portion 216 are configured to be fixed to the first ground conductive pad GP1, the second ground conductive pad GP2, the third ground conductive pad GP3 and the fourth ground conductive pad GP4, respectively. The first groove 2213, the second groove 2223, the third groove 2233 and the ventilation groove 2161 facilitate filling soldering mater (for example, solder) to improve soldering quality. The third surrounding wall 223 includes a second positioning groove 2231 and a contact tab 2234 protruding away from the shielding side plate 21.

In the third embodiment of the present disclosure, the plurality of shielding pieces 22 are arranged along the second direction A2-A2. The first surrounding wall 221 of one of the two adjacent shielding pieces 22 is disposed close to the second surrounding wall 222 of a remaining one of the two adjacent shielding pieces 22. The first mounting protrusion tab 2211 of the first surrounding wall 221 of one of the two adjacent shielding pieces 22 is inserted into a corresponding first receiving groove 2111 or a corresponding second receiving groove 2112 together with the second mounting protrusion tab 2221 of the second surrounding wall 222 of a remaining one of the two adjacent shielding pieces 22. In one embodiment of the present disclosure, the first surrounding wall 221 of one of the two adjacent shielding pieces 22 and the second surrounding wall 222 of a remaining one of the two adjacent shielding pieces 22 are abutted against each other.

In the third embodiment of the present disclosure, the shielding shell assembly 2 further includes a plurality of connecting plates 23. In the third embodiment of the present disclosure, each connecting plate 23 is made of a metal material, which includes a base body portion 231, a first protruding piece portion 234 located at one end of the base body portion 231, and a second protruding piece portion 235 located at another end of the base body portion 231. The base body portion 231 defines a plurality of grooves 2310 that extend upwardly through the base body portion 231. The first protruding piece portion 234 is provided with a third fastening elastic arm 2341. The second protruding piece portion 235 is provided with a fourth fastening elastic arm 2351. The third fastening elastic arm 2341 and the fourth fastening elastic arm 2351 are both inclined, and are stamped sidewardly from the first protruding piece portion 234 and the second protruding piece portion 235, respectively. A third end portion 2341a of the third fastening elastic arm 2341 and a fourth end portion 2351a of the fourth fastening elastic arm 2351 are locked in the mounting frame 1 to prevent the connecting plate 23 from disengaging from the mounting frame 1 in the direction opposite to the assembly direction.

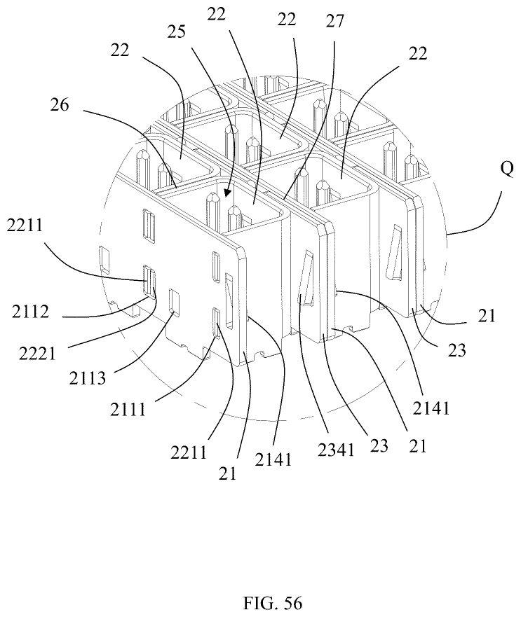

Referring to FIG. 56 and FIG. 64, in the third embodiment of the present disclosure, on one connecting plate 23 and one shielding side plate 21 which are attached to each other, the first fastening arm 2141 of the shielding side plate 21 and the third fastening arm 2341 of the connecting plate 23 are symmetrically disposed, and are opposite in protruding directions. The second fastening arm 2151 of the shielding side plate 21 and the fourth fastening arm 2351 of the connecting plate 23 are symmetrically disposed, and are opposite in protruding directions. The contact tab 2234 is in contact with the base body portion 231 to improve the ground shielding effect.

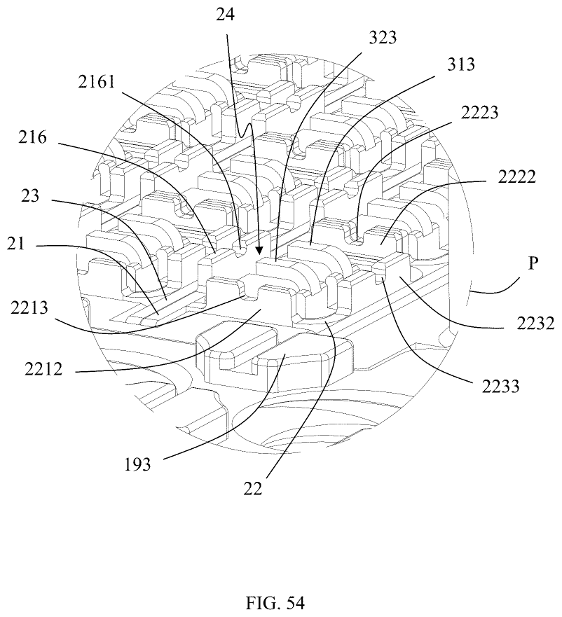

It is understandable to those skilled in the art that in the third embodiment of the present disclosure, the connecting plate 23 itself is not provided with any mounting tail 2313 as in the first embodiment. On the contrary, the present disclosure provides the third mounting portion 2232 on the third surrounding wall 223 and the mounting projection portion 216 on the shielding side plate 21. Referring to FIG. 53 and FIG. 54, in the third embodiment of the present disclosure, the first mounting portion 2212, the second mounting portion 2222, the third mounting portion 2232 and the mounting projection portion 216 jointly form a shielding space 24. Preferably, a bottom surface of the first mounting portion 2212, a bottom surface of the second mounting portion 2222, a bottom surface of the third mounting portion 2232 and a bottom surface of the mounting projection portion 216 are located in a same plane for being easily fixed to the circuit board 300 by soldering or welding.

In the illustrated embodiment of the present disclosure, the shielding piece 22 and the shielding side plate 21 form a rectangular and circumferentially surrounded shielding cavity 25 to accommodate the terminal module 3. By providing the U-shaped shielding pieces 22 to mate with the shielding side plate 21 to form the plurality of shielding cavities 25, the volume of each shielding cavity 25 can be relatively small, thereby facilitating the increase of signal transmission rate. In addition, any two adjacent shielding cavities 25 disposed in the second direction A2-A2 are separated by a first multilayer wall 26 between the two shielding cavities 25, thereby facilitating the improvement of the shielding effect. The first multilayer wall 26 includes the second surrounding wall 222 of one shielding piece 22 and the first surrounding wall 221 of another shielding piece 22. Any two adjacent shielding cavities 25 disposed in the third direction A3-A3 are separated by a second multilayer wall 27 between the two shielding cavities 25, thereby facilitating the improvement of the shielding effect. The second multilayer wall 27 includes the third surrounding wall 223, the connecting plate 23, and the shielding side plate 21.

Besides, in the illustration embodiment of the present disclosure, by providing the connecting plate 23, it is beneficial to appropriately increase the spacing between two adjacent shielding modules 30 in the third direction A3-A3, thereby facilitating the arrangement of conductive pads on the circuit board 300.

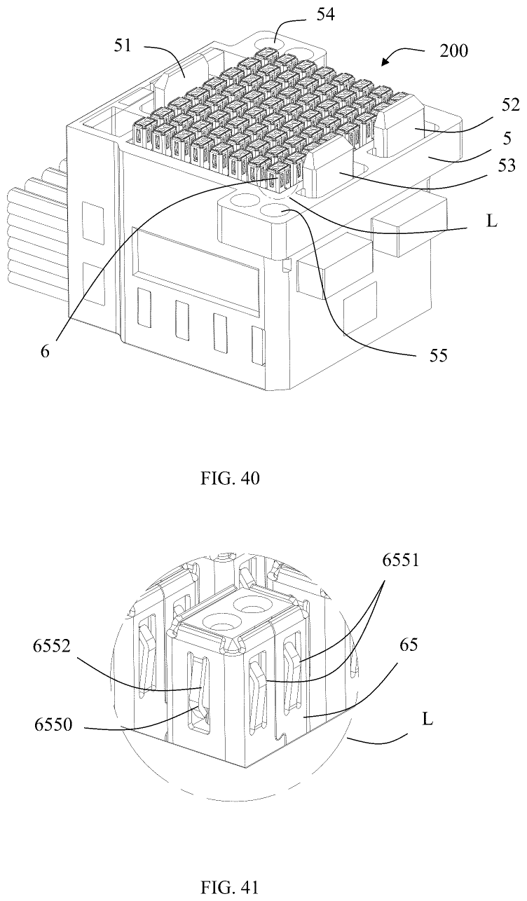

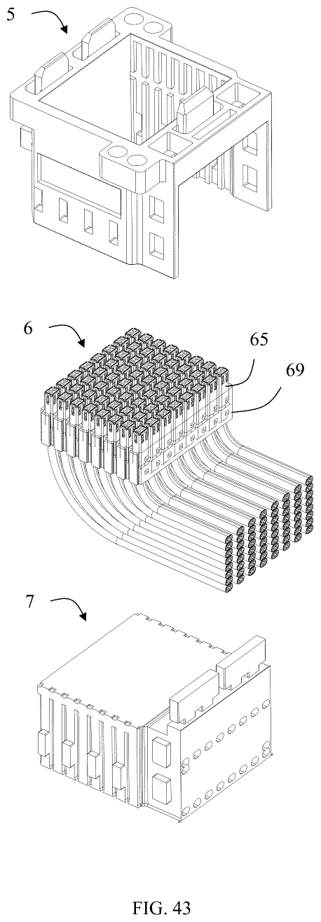

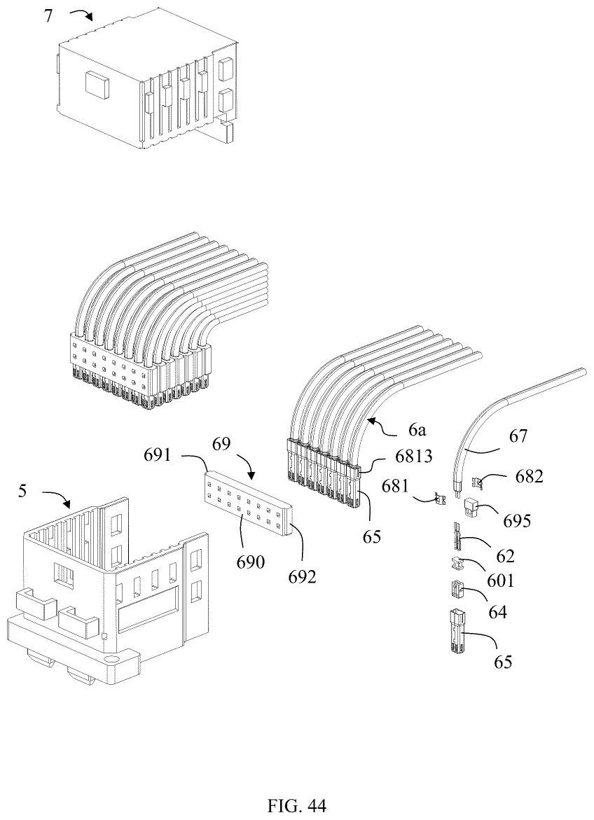

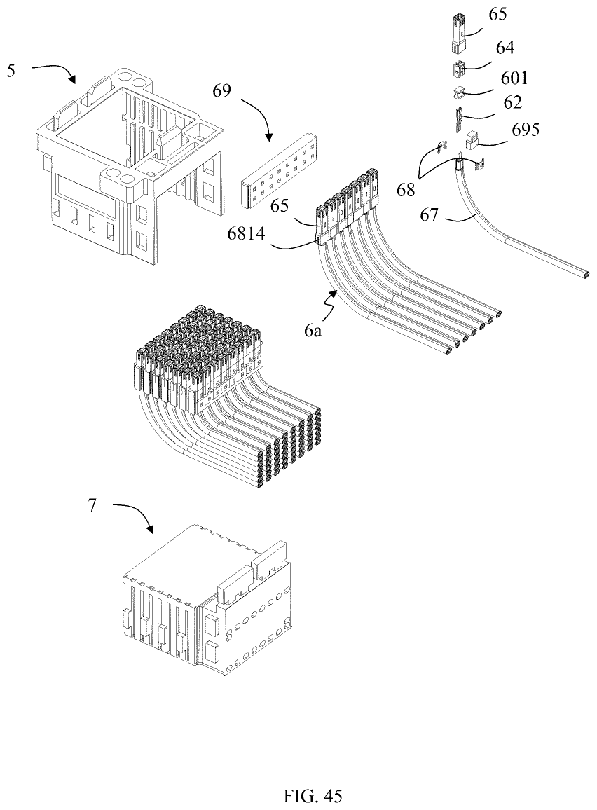

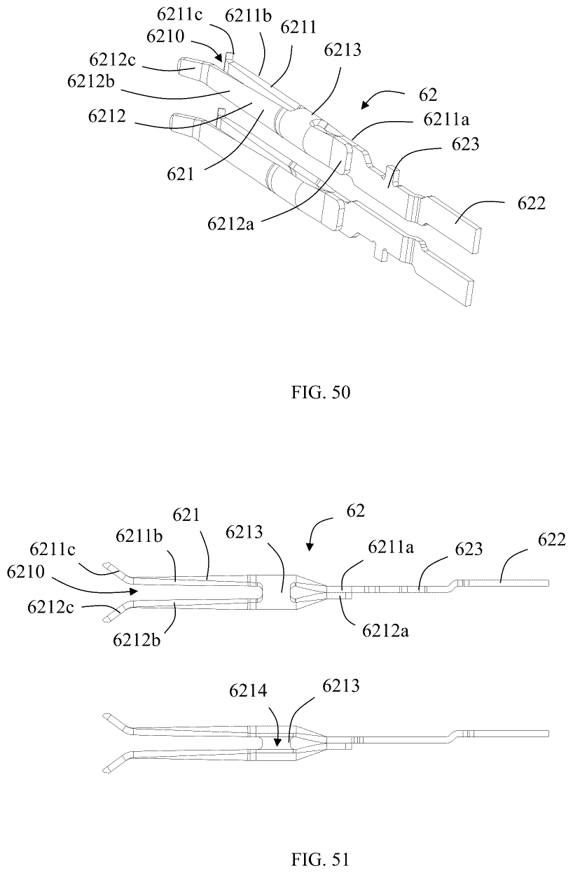

Referring to FIG. 40 to FIG. 51, the mating connector includes an accommodating housing 5, a plurality of cable modules 6 located at least partially in the accommodating housing 5, and an over-molding housing 7 formed on the cable modules 6 and fixed to the accommodating housing 5. In one embodiment of the present disclosure, the accommodating housing 5 is a metal housing made of a metal material. For example, the accommodating housing 5 is manufactured in the form of powder metallurgy to improve structural strength and shielding effect. Referring to FIG. 40, in a first embodiment of the mating connector of the present disclosure, the accommodating housing 5 is provided with a first positioning plate 51 which is located on one side, and a second positioning plate 52 and a third positioning plate 53 which are located on another side. The first positioning plate 51 is configured to be inserted into the first guide groove 1321. The second positioning plate 52 is configured to be inserted into the second guide groove 1421. The third positioning plate 53 is configured to be inserted into the third guide groove 1431.

Besides, the accommodating housing 5 defines a first assembly hole 54 and a second assembly hole 55. The connector assembly includes a plurality of fasteners that secure the mating connector and the electrical connector 100 together. The fasteners include a third screw 403 and a fourth screw 404. The third screw 403 passes through the first assembly hole 54 and is fixed in the electrical connector 100. The fourth screw 404 passes through the second assembly hole 55 and is fixed in the electrical connector 100.

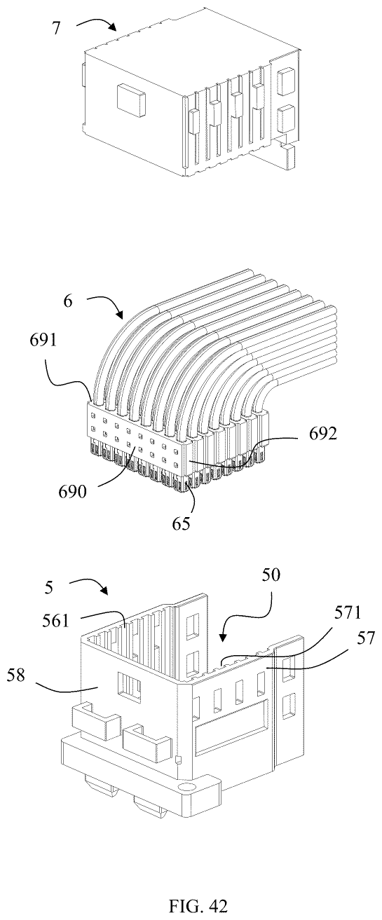

Referring to FIG. 42 to FIG. 45, in the first embodiment of the mating connector, the accommodating housing 5 includes a first outer wall 56, a second outer wall 57 disposed opposite to the first outer wall 56, and a connecting wall 58 connecting one end of the first outer wall 56 and one end of the second outer wall 57. The accommodating housing 5 includes a receiving space 50 between the first outer wall 56 and the second outer wall 57. An inner surface of the first outer wall 56 defines a plurality of first mounting slots 561 communicating with the receiving space 50. An inner surface of the second outer wall 57 defines a plurality of second mounting slots 571 communicating with the receiving space 50. The first mounting slots 561 are aligned with corresponding second mounting slots 571 to hold corresponding cable modules 6.

Referring to FIG. 42 to FIG. 51, in the first embodiment of the mating connector, each cable module 6 includes a plurality of cable blocks 6a disposed at intervals, a plurality of metal shield enclosures 65 sleeved on the cable blocks 6a, and a fixing block 69 fixed on the plurality of cable blocks 6a and the metal shield enclosures 65. In one embodiment of the present disclosure, the fixing block 69 is made of insulating material, and is over-molded on the plurality of cable blocks 6a and the metal shield enclosures 65, so as to be combined with the cable blocks 6a and the metal shield enclosures 65 as a whole. In the illustrated embodiment of the present disclosure, the fixing block 69 is embedded in slots of the cable blocks 6a during molding so as to increase the bonding force therebetween. Of course, it is understandable to those skilled in the art that the plurality of cable blocks 6a can also be fixed to the fixing block 69 through assembly or other methods, which will not be described in detail in the present disclosure.

Referring to FIG. 42, the fixing block 69 includes a main portion 690, a first positioning block 691 connected to one side of the main portion 690 and protruding out of the main portion 690, and a second positioning block 692 connected to another side of the main portion 690 and protruding out of the main portion 690. In the illustrated embodiment of the present disclosure, the first positioning block 691 is received in the first mounting slot 561. The second positioning block 692 is received in the second mounting slot 571.

Each cable block 6a includes an insulating block 64, a terminal module 60 mounted to the insulating block 64, a cable 67 electrically connected to the terminal module 60, a shielding clamp 68 clamping the cable 67, and an over-molding block 695 at least partially fixed on the terminal module 60, the shielding clamp 68 and the cable 67. The metal shield enclosure 65 is at least partially sleeved on the insulating block 64, the terminal module 60 and the over-molding block 695. The technical term of “electrically connected” used throughout the present disclosure includes contact connection or non-contact connection, where non-contact connection includes using a transition element to realize the connection between the two components.

In the illustrated embodiment of the present disclosure, the over-molding block 695 is made of insulating material, and is over-molded on the insulating block 64, the terminal module 60, the shielding clamp 68 and the cable 67 to be combined into a whole.

The terminal module 60 includes a holding block 601 and a plurality of cable terminals 62 fixed to the holding block 601. In one embodiment of the present disclosure, the cable terminals 62 are insert-molded with the holding block 601. Of course, in other embodiments, the cable terminals 62 can also be fixed to the holding block 601 through assembly. In the illustrated embodiment of the present disclosure, the holding block 601 includes a slot 6011 which extends along a circumferential direction of the holding block 601.

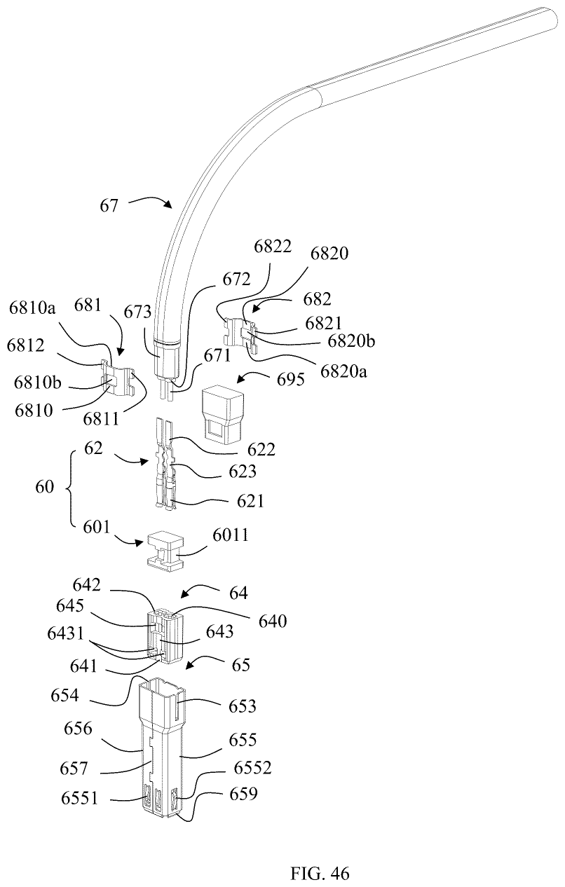

Referring to FIG. 46 to FIG. 51, in the illustrated embodiment of the present disclosure, each group of cable terminals 62 includes a mating portion 621, a cable connecting portion 622, and an intermediate portion 623 connecting the mating portion 621 and the cable connecting portion 622. The intermediate portion 623 is at least partially fixed in the holding block 601. The mating portions 621 extend beyond the holding block 601 for contacting the first conductive terminals 31 and the second conductive terminals 32 of the electrical connector 100. The cable connecting portions 622 extend beyond the holding block 601 for being electrically connected to the cable 67. In one embodiment of the present disclosure, the two intermediate portions 623 of a set of cable terminals 62 are narrow-sided coupled. Of course, it is understandable to those skilled in the art that in other embodiments of the present disclosure, the two intermediate portions 623 of the set of cable conductive terminals 62 may also be wide-sided coupled.

In one embodiment of the present disclosure, two cable terminals 62 are provided in each terminal module 60. The two cable terminals 62 are mating signal terminals which form a pair of second differential signal terminals to increase the signal transmission rate.

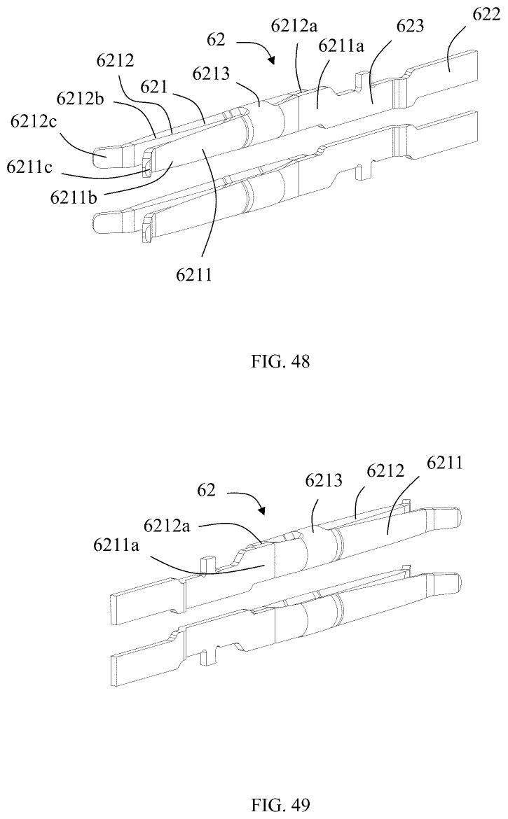

Referring to FIG. 48 to FIG. 51, in the illustrated embodiment of the present disclosure, the mating portion 621 of each cable terminal 62 has a two-half structure. The mating portion 621 of each cable terminal 62 includes a first elastic arm 6211, a second elastic arm 6212 disposed opposite to the first elastic arm 6211, and a connecting wall portion 6213 connecting one side of the first elastic arm 6211 and one side of the second elastic arm 6212. The first elastic arm 6211 includes a first tail end portion 6211a connected to the intermediate portion 623 and a first contact arm 6211b extending forwardly. The first contact arm 6211b is provided with a first end portion 6211c located at a free end thereof. The second elastic arm 6212 includes a second tail end portion 6212a in contact with the first tail end portion 6211a, and a second contact arm 6212b. The second contact arm 6212b is provided with a second end portion 6212c located at a free end thereof. The connecting wall portion 6213 is located between the first contact arm 6211b and the first tail end portion 6211a, and the connecting wall portion 6213 is also located between the second contact arm 6212b and the second tail end portion 6212a.

In the illustrated embodiment of the present disclosure, the first elastic arm 6211 and the second elastic arm 6212 are connected to each other only through the connecting wall portion 6213. In other words, a position of the cable terminal 62 opposite to the connecting wall portion 6213 is an opening slot 6214 formed between the first elastic arm 6211 and the second elastic arm 6212, so that the first elastic arm 6211 and the second elastic arm 6212 have better elastic deformation capabilities. In the illustrated embodiment of the present disclosure, the cable terminal 62 includes a clamping space 6210 between the first elastic arm 6211 and the second elastic arm 6212 to receive the first contact portion 312 and the second contact portion 322 of the differential signal terminals of the electrical connector 100. The first end portion 6211c and the second end portion 6212c together form a bell mouth configuration to guide the first contact portion 312 and the second contact portion 322 of the differential signal terminals to be inserted into the clamping space 6210.

The cable terminal 62 of the present disclosure includes the second tail end portion 6212a which is in contact with the first tail end portion 6211a. In one embodiment of the present disclosure, the second tail end portion 6212a is fixed to the first tail end portion 6211a by soldering or welding. It is understandable to those skilled in the art that when a signal is transmitted through the second elastic arm 6212, the signal can be transmitted through the following path: the second elastic arm 6212 the second tail end portion 6212a the first tail end portion 6211a the intermediate portion 623 the cable connecting portion 622 he cable 67. In other words, when a signal is transmitted through the second elastic arm 6212, the signal does not have to pass through the connecting wall 6213 before being transmitted to the cable 67, thereby improving the efficiency of signal transmission.

In the illustrated embodiment of the present disclosure, each insulating block 64 includes a first end surface 641, a second end surface 642 disposed opposite to the first end surface 641, and at least one terminal receiving hole 640 extending through the first end surface 641 and the second end surface 642 along the first direction A1-A1. In the illustrated embodiment of the present disclosure, the insulating block 64 is generally in the shape of a rectangular parallelepiped, and includes a first side wall 643 and a second side wall 644 disposed opposite to the first side wall 643. The first side wall 643 further defines a plurality of first opening holes 6431 extending through the first side wall 643 and communicating with the terminal receiving hole 640. The second side wall 644 further defines a plurality of second opening holes 6441 extending through the second side wall 644 and communicating with the terminal receiving hole 640. In addition, the insulating block 64 is further provided with a grooved portion 645 in communication with the terminal receiving hole 640, and the grooved portion 645 is configured to adjust the impedance.

The cable 67 includes a core 671 for being electrically connected to the cable connecting portion 622 of the differential signal terminals, an insulating layer 672 wrapped around the core 671, and a shielding layer 673 located on an outer layer of the insulating layer 672. In one embodiment of the present disclosure, the core 671 and the cable connecting portion 622 of the differential signal terminals are fixed by soldering or welding. In the illustrated embodiment of the present disclosure, the shielding layer 673 is in contact with the shielding clamp 68.

In the illustrated embodiment of the present disclosure, the shielding clamp 68 is made of metal material. The shielding clamp 68 includes a first clamping plate portion 681 and a second clamping plate portion 682. The first clamping plate portion 681 and the second clamping plate portion 682 are clamped and fixed on the cable 67. The first clamping plate portion 681 and the second clamping plate portion 682 are both in contact with the shielding layer 673. In the illustrated embodiment of the present disclosure, the shielding layer 673 is sandwiched by the first clamping plate portion 681 and the second clamping plate portion 682.

Of course, it is understandable to those skilled in the art that the cable 67 can be a cable having a single ground wire, a double ground wire or no ground wire in the prior art. When the cable 67 adopts the cable having the single ground wire or the double ground wire, the ground wire is configured to be in contact with the shielding clamp 68 to achieve ground conduction. When the cable 67 is a cable without the ground wire, the cable 67 is provided with a shielding layer which is configured to be in contact with the shielding clamp 68 to achieve ground conduction.

In the illustrated embodiment of the present disclosure, the first clamping plate portion 681 includes a first clamping portion 6810, a first tab portion 6811 extending from the first clamping portion 6810 to one side, and a second tab portion 6812 extending from the first clamping portion 6810 to another side. The first clamping portion 6810 has an arc-shaped first inner surface 6810a and a first opening 6810b extending through the first clamping portion 6810.

The second clamping plate portion 682 includes a second clamping portion 6820, a third tab portion 6821 extending from the second clamping portion 6820 to one end, and a fourth tab portion 6822 extending from the second clamping portion 6820 to another end. The second clamping portion 6820 has an arc-shaped second inner surface 6820a and a second opening 6820b extending through the second clamping portion 6820.

The first clamping portion 6810 and the second clamping portion 6820 jointly clamp the cable 67. The first opening 6810b and the second opening 6820b can be filled with solder, so that the shielding clamp 68 and the shielding layer 673 can be easily soldered.

In the illustrated embodiment of the present disclosure, the first tab portion 6811 and the third tab portion 6821 abut against each other to form a first insertion tab 6813. The second tab portion 6812 and the fourth tab portion 6822 abut against each other to form a second insertion tab 6814. The first insertion tab 6813 and the second insertion tab 6814 are both in contact with the metal shield enclosure 65.

In an embodiment of the present disclosure, the over-molding block 695 is over-molded on the terminal module 60, the shielding clamp 68 and the cable 67, so as to be integrated with the terminal module 60, the shielding clamp 68 and the cable 67. Specifically, the over-molding block 695 is embedded in the slot 6011 of the holding block 601 to improve the combination reliability thereof. The first insertion tab 6813 and the second insertion tab 6814 extend oppositely to protrude beyond the over-molding block 695, respectively.

The metal shield enclosure 65 is at least partially sleeved on the insulating block 64, the terminal module 60 and the over-molding block 695 in order to better shield the cable terminals 62. The metal shield enclosure 65 includes a shielding cavity 650 in which the insulating block 64 and the terminal module 60 are at least partially located.

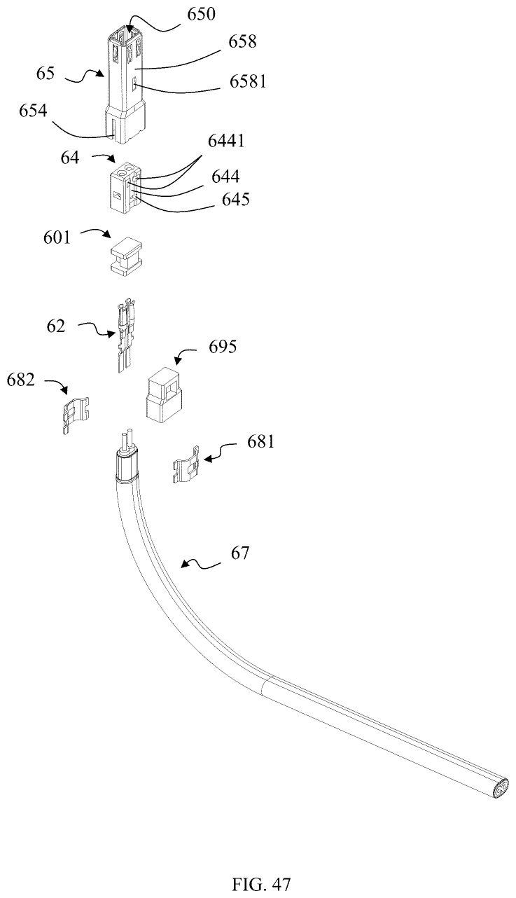

Referring to FIG. 41, FIG. 46 and FIG. 47, in one embodiment of the present disclosure, the metal shield enclosure 65 is of a one-piece structure, and includes a first outer wall portion 655, a second outer wall portion 656 disposed opposite to the first outer wall portion 655, a third outer wall portion 657, and a fourth outer wall portion 658 disposed opposite to the third outer wall portion 657. The shielding cavity 650 is enclosed by the first outer wall portion 655, the second outer wall portion 656, the third outer wall portion 657, and the fourth outer wall portion 658. Specifically, in the illustrated embodiment of the present disclosure, the first outer wall portion 655 defines a first clamping slot 653. The second outer wall portion 656 defines a second clamping slot 654. The first insertion tab 6813 is inserted into the first clamping slot 653, and the second insertion tab 6814 is inserted into the second clamping slot 654 so as to improve the shielding effect. Preferably, after the first insertion tab 6813 is inserted into the first clamping slot 653, it is fixed with the first outer wall portion 655 by soldering or welding. After the second insertion tab 6814 is inserted into the second clamping slot 654, it is fixed with the second outer wall portion 656 by soldering or welding.

One end of the metal shield enclosure 65 is provided with a plurality of inclined chamfered portions 659 to prevent the insulating block 64 from being disengaged from the metal shield enclosure 65 after being received in the shielding cavity 650. In the illustrated embodiment of the present disclosure, the fourth outer wall portion 658 is further provided with a locking tab 6581 protruding inwardly. The locking tab 6581 is configured to lock with the insulating block 64 to improve the installation reliability between the metal shield enclosure 65 and the insulating block 64, and prevent the two from being separated. In the illustrated embodiment of the present disclosure, the locking tab 6581 is integrally stamped from the fourth outer wall portion 658 inwardly. The locking tab 6581 is of a cantilever-shaped configuration. A free end of the locking tab 6581 abuts against the insulating block 64.

Referring to FIG. 41, in the illustrated embodiment of the present disclosure, the metal shield enclosure 65 further includes at least one contact elastic arm 6550 integrally stamped outward. The at least one contact elastic arm 6550 includes at least one first contact elastic arm 6551 and at least one second contact elastic arm 6552. The first contact elastic arm 6551 and the second contact elastic arm 6552 extend in opposite directions. The first contact elastic arm 6551 and the second contact elastic arm 6552 are located on two adjacent outer wall portions in a circumferential direction of the metal shield enclosure 65.

When the cable connector 200 is mating with the electrical connector 100, the metal shield enclosures 65 of the cable connector 200 pass through the module receiving holes 151 to be at least partially accommodated in the shielding cavities 25 of the electrical connector 100. The mating portions 621 of the cable conductive terminals 62 come into contact with the first contact portion 312 of the first conductive terminal 31 and the second contact portion 322 of the second conductive terminal 32. The contact elastic arm 6550 elastically abuts against the shielding shell assembly 2, thereby improving the shielding effect. Specifically, the first contact elastic arm 6551 elastically abuts against the shielding side plate 21 and the third surrounding wall 223 of the shielding piece 22, respectively. The second contact elastic arm 6552 elastically abuts against the first surrounding wall 221 and the second surrounding wall 222 of the shielding piece 22, respectively.

Of course, it is understandable to those skilled in the art that the contact elastic arm 6550 may also be disposed on the shielding shell assembly 2. The contact elastic arm 6550 protrudes into the shielding cavity 25 to be in contact with the metal shield enclosure 65 of the cable connector 200. For example, the contact elastic arm 6550 may be provided on at least one of the shielding side plate 21 and the connecting plate 23.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. An electrical connector, comprising:
a mounting frame, the mounting frame comprising a base plate portion and a mounting space, the base plate portion defines a plurality of module receiving holes; and
a shielding module, the shielding module being at least partially received in the mounting space; the shielding module comprising a shielding shell assembly and a plurality of terminal modules; the shielding shell assembly defining a plurality of shielding cavities, the terminal modules being at least partially received in the shielding cavities; the module receiving holes corresponding to and communicating with the shielding cavities.

2. The electrical connector according to claim 1, wherein the module receiving holes are arranged in a grid pattern.

3. The electrical connector according to claim 1, wherein each module receiving hole is a circumferentially closed hole.

4. The electrical connector according to claim 1, wherein the mounting frame comprises a first wall portion connected to the base plate portion and located on a first side of the base plate portion, and a second wall portion connected to the base plate portion and located on a second side of the base plate portion;
an inner side of the first wall portion defines a first mounting groove, an inner side of the second wall portion defines a second mounting groove, both the first mounting groove and the second mounting groove communicate with the mounting space;
the shielding shell assembly comprises a shielding side plate; the shielding side plate comprises a plate body portion, a first insertion piece portion located at one end of the plate body portion, and a second insertion piece portion located at another end of the plate body portion; the first insertion piece portion is received in the first mounting groove, and the second insertion piece portion is received in the second mounting groove.

5. The electrical connector according to claim 4, wherein the first insertion piece portion is provided with a first locking elastic arm; the first locking elastic arm is provided with a first locking protrusion; the second insertion piece portion is provided with a second locking elastic arm; and the second locking elastic arm is provided with a second locking protrusion;
the first wall portion defines a first locking hole communicating with the first mounting groove; the second wall portion defines a second locking hole communicating with the second mounting groove; the first locking protrusion is locked and fixed in the first locking hole, and the second locking protrusion is locked and fixed in the second locking hole.

6. The electrical connector according to claim 5, wherein the shielding shell assembly further comprises a connecting plate abutting against the shielding side plate; the connecting plate is provided with a base body portion, a first protruding piece portion located at one end of the base body portion, and a second protruding piece portion located at another end of the base body portion; the first protruding piece portion and the first insertion piece portion are together inserted into the first mounting groove; the second protruding piece portion and the second insertion piece portion are together inserted into the second mounting groove; the first protruding piece portion is provided with a first retaining elastic arm; the first retaining elastic arm is provided with a first retaining protrusion; the first retaining protrusion and the first locking protrusion are together locked and fixed in the first locking hole; the second protruding piece portion is provided with a second retaining elastic arm; the second retaining elastic arm is provided with a second retaining protrusion; and the second retaining protrusion and the second locking protrusion are together locked and fixed in the second locking hole.

7. The electrical connector according to claim 6, wherein the connecting plate is provided with an abutting elastic arm elastically abutting against the shielding side plate.

8. The electrical connector according to claim 6, wherein the connecting plate is provided with a mounting tail configured to be fixed to a circuit board by soldering or welding.

9. The electrical connector according to claim 4, wherein the shielding shell assembly comprises a shielding piece cooperating with the shielding side plate, the shielding piece comprises a first surrounding wall, a second surrounding wall disposed opposite to the first surrounding wall, and a third surrounding wall connected between the first surrounding wall and the second surrounding wall; the shielding cavity is jointly formed by the shielding side plate and the shielding piece.

10. The electrical connector according to claim 9, wherein the plate body portion of the shielding side plate defines a first receiving groove and a second receiving groove;
the first surrounding wall is provided with a first mounting protrusion tab inserted into the first receiving groove; and the second surrounding wall is provided with a second mounting protrusion tab inserted into the second receiving groove.

11. The electrical connector according to claim 10, wherein the first mounting protrusion tab is fixed to the plate body portion by soldering or welding; and the second mounting protrusion tab is fixed to the plate body portion by soldering or welding.

12. The electrical connector according to claim 9, wherein the plate body portion defines a first positioning groove, and the third surrounding wall defines a second positioning groove;
the terminal module comprises an insulating block, a first conductive terminal fixed to the insulating block, and a second conductive terminal fixed to the insulating block; the insulating block is received in the shielding cavity; the insulating block is provided with a first protruding rib inserted into the first positioning groove and a second protruding rib inserted into the second positioning groove;
the first conductive terminal is provided with a first contact portion protruding beyond the insulating block and extending into the shielding cavity; and the second conductive terminal is provided with a second contact portion protruding beyond the insulating block and extending into the shielding cavity.

13. The electrical connector according to claim 1, wherein the mounting frame comprises an inner frame and an outer frame; the inner frame and the outer frame are separately formed; and the inner frame is disposed in the outer frame.

14. The electrical connector according to claim 13, wherein the inner frame is an insulating inner frame, and the outer frame is a metal outer frame.

15. The electrical connector according to claim 1, wherein the mounting frame is of a one-piece configuration, and the mounting frame is a metal frame.

16. A connector assembly, comprising:
an electrical connector comprising:
a mounting frame, the mounting frame comprising a base plate portion and a mounting space, the base plate portion defines a plurality of module receiving holes; and
a shielding module, the shielding module being at least partially received in the mounting space; the shielding module comprising a shielding shell assembly and a plurality of terminal modules; the shielding shell assembly defining a plurality of shielding cavities, the terminal modules being at least partially received in the shielding cavities; the module receiving holes corresponding to and communicating with the shielding cavities; and
a mating connector comprising a plurality of metal shield enclosures;
wherein the metal shield enclosures are configured to pass through the module receiving holes of the electrical connector to be at least partially received in the shielding cavities of the electrical connector.

17. The connector assembly according to claim 16, wherein each metal shield enclosure is provided with a contact elastic arm elastically abutting against the shielding shell assembly of the electrical connector.

18. The connector assembly according to claim 16, wherein the mounting frame comprises a first wall portion connected to the base plate portion and located on a first side of the base plate portion, and a second wall portion connected to the base plate portion and located on a second side of the base plate portion;
an inner side of the first wall portion defines a first mounting groove, an inner side of the second wall portion defines a second mounting groove, both the first mounting groove and the second mounting groove communicate with the mounting space;
the shielding shell assembly comprises a shielding side plate; the shielding side plate comprises a plate body portion, a first insertion piece portion located at one end of the plate body portion, and a second insertion piece portion located at another end of the plate body portion; the first insertion piece portion is received in the first mounting groove, and the second insertion piece portion is received in the second mounting groove.

19. The connector assembly according to claim 18, wherein the first insertion piece portion is provided with a first locking elastic arm; the first locking elastic arm is provided with a first locking protrusion; the second insertion piece portion is provided with a second locking elastic arm; and the second locking elastic arm is provided with a second locking protrusion;
the first wall portion defines a first locking hole communicating with the first mounting groove; the second wall portion defines a second locking hole communicating with the second mounting groove; the first locking protrusion is locked and fixed in the first locking hole, and the second locking protrusion is locked and fixed in the second locking hole

20. The connector assembly according to claim 19, wherein the shielding shell assembly further comprises a connecting plate abutting against the shielding side plate; the connecting plate is provided with a base body portion, a first protruding piece portion located at one end of the base body portion, and a second protruding piece portion located at another end of the base body portion; the first protruding piece portion and the first insertion piece portion are together inserted into the first mounting groove; the second protruding piece portion and the second insertion piece portion are together inserted into the second mounting groove; the first protruding piece portion is provided with a first locking elastic arm; the first locking elastic arm is provided with a first locking protrusion; the first locking protrusion and the first locking protrusion of the shielding side plate are together locked and fixed in the first locking hole; the second protruding piece portion is provided with a second locking elastic arm; the second locking elastic arm is provided with a second locking protrusion; and the second locking protrusion and the second locking protrusion of the shielding side plate are together locked and fixed in the second locking hole.
